(19) United States
(12) Patent Application Publication
(10) Pub. No.: US 2026/0020997 A1
(43) Pub. Date: Jan. 22, 2026

(54) OXYGEN TANK SUPPORTS FOR A PATIENT SUPPORT APPARATUS

(71) Applicant: Hill-Rom Services, Inc., Batesville, IN (US)

(72) Inventors: Scott M. Corbin, Sunman, IN (US); Andrew Dole, Batesville, IN (US); Brian Guthrie, Greensburg, IN (US); Edward J. Koors, Indianapolis, IN (US); David C. Newkirk, Lawrenceburg, IN (US); Jonathan D. Turner, Dillsboro, IN (US); Michael J. Viltro, Hamilton, OH (US); Robert Mark Zerhusen, Cincinnati, OH (US)

(21) Appl. No.: 19/271,229

(22) Filed: Jul. 16, 2025

Related U.S. Application Data
(60) Provisional application No. 63/673,386, filed on Jul. 19, 2024.
(60) Provisional application No. 63/768,944, filed on Mar. 8, 2025.

(51) Int. Cl. A61G 7/05; A61G 7/012

(52) U.S. Cl. CPC A61G 7/0503; A61G 7/012

(57) ABSTRACT

A patient support apparatus includes a frame adapted to be raised and lowered relative to a floor underlying the patient support apparatus and an oxygen tank support configured to couple an oxygen tank with the patient support apparatus. The frame is adapted to operably support a patient thereon and the oxygen tank support is coupled with the frame and is adapted to increase caregiver access to the patient.

### CROSS-REFERENCE TO RELATED APPLICATIONS

This application claims priority to U.S. Provisional Patent Application No. 63/673,386, filed Jul. 19, 2024 and titled “OXYGEN TANK SUPPORTS FOR A PATIENT SUPPORT APPARATUS,” and to U.S. Provisional Patent Application No. 63/768,944, filed Mar. 8, 2025 and titled “OXYGEN TANK SUPPORTS FOR A PATIENT SUPPORT APPARATUS,” which are each incorporated by reference herein.

### BACKGROUND

The present disclosure is related to a patient support apparatus such as a bed, stretcher, wheelchair, table, and the like that is adaptable to various levels of acuity to provide support to a patient with minimal caregiver assistance. More particularly, the present disclosure relates to patient support apparatuses having therapy delivery devices integrated therewith.

Patient support apparatuses such as hospital beds and stretchers conventionally have features adapted to provide therapy to the patient, as well as to assist the caregiver in positioning and transporting the patient. For example, patient support apparatuses can include articulating sections to allow the patient to be placed in a variety of positions for comfort of the patient and to assist the caregiver in caring for the patient. Patient support apparatuses may also include therapy delivery devices thereon to provide the caregiver prompt access to certain therapies for the patient.

As one example of a therapy delivery device, some patient support apparatuses include an oxygen tank support for storing an oxygen tank thereon. In some conventional patient support apparatuses, the oxygen tank support may be coupled to a head end of the patient support apparatus in a fixed position to provide the caregiver prompt access to the oxygen tank. In other conventional patient support apparatuses, the oxygen tank support is located under the patient, between an upper frame and a base of the patient support apparatus. However, conventional oxygen tank supports may obstruct the caregiver's access to the patient or the mobility of the articulating sections of the patient support apparatus.

Thus, there is a need for a patient support apparatus with an oxygen tank support that provides increased caregiver access to the patient while also providing prompt caregiver access to the oxygen tank. The present disclosure is directed to apparatuses and methods to support an oxygen tank on a patient support apparatus to increase caregiver access to the patient.

### SUMMARY

The present disclosure includes one or more of the features recited in the appended claims and/or the following features which, alone or in any combination, may comprise patentable subject matter.

According to a first aspect of the present disclosure, a patient support apparatus comprises a base, an upper frame operably coupled with the base, a lift assembly, and an oxygen tank support. The lift assembly is coupled to the base and the upper frame to move the upper frame vertically relative to the base. The oxygen tank support is configured for storing an oxygen tank thereon. The oxygen tank support is operably coupled with the upper frame to rotate about a vertically oriented axis to allow the oxygen tank support to be moved selectively to a plurality of positions relative to the upper frame about the vertically oriented axis.

In some embodiments of the first aspect, the oxygen tank support includes a swivel mount and a tank holder. The swivel mount is rotatably coupled with the upper frame for rotation about the axis. The tank holder is coupled with the swivel mount and configured to extend around the oxygen tank.

In some embodiments of the first aspect, the tank holder includes a first band coupled with the swivel mount and configured to extend around the oxygen tank. In some embodiments of the first aspect, the swivel mount includes a first end and a second end that extends away from the first end and curves to extend toward the first end and the second end is rotatably coupled with the upper frame to rotate about the axis.

In some embodiments of the first aspect, the first band includes a sidewall and an end wall. The sidewall is configured to extend around the oxygen tank. The end wall is coupled with the sidewall and configured to support a bottom of the oxygen tank.

In some embodiments of the first aspect, the oxygen tank holder includes a second band coupled with the swivel mount and spaced apart from the first band. In some embodiments of the first aspect, the oxygen tank holder includes rails that extend away from the first band and provide an end wall to support a weight of the oxygen tank.

In some embodiments of the first aspect, the swivel mount includes a release lock configured to block inadvertent separation of the swivel mount away from the upper frame. The release lock is configured to be activated by a caregiver to allow intentional separation of the swivel mount from the upper frame.

In some embodiments of the first aspect, the upper frame includes a frame member and a first handle operably coupled to the frame member. The oxygen tank holder is rotatably coupled with the frame member.

In some embodiments of the first aspect, the upper frame includes support retainers coupled with the frame member and configured to engage the oxygen tank support to locate the oxygen tank support in a predetermined position and to resist rotation of the oxygen tank support about the axis away from the predetermined position. In some embodiments of the first aspect, the support retainers includes a pair of tabs that extend away from the frame member.

According to a method of using a patient support apparatus in accordance with the first aspect, the method includes support an oxygen tank on an oxygen tank support coupled to an upper frame of the patient support apparatus, and moving the oxygen tank support from a first position to a second position relative to the upper frame.

In some embodiments of the first aspect, the oxygen tank support is pivotably coupled with the upper frame. In some embodiments of the first aspect, the oxygen tank support includes a swivel mount pivotably coupled with the upper frame and a tank holder coupled with the swivel mount and adapted to support the oxygen tank.

In some embodiments of the first aspect, the upper frame includes a frame member and a support retainer configured to resist movement of the oxygen tank support away from a predetermined position relative to the upper frame. In some embodiments of the first aspect, the swivel mount is received in a hole formed in the frame member and is configured to rotate about a vertical axis that extends through the frame member.

According to a second aspect of the present disclosure, a patient support apparatus includes a frame operable to move vertically relative to a floor underlying the frame and an oxygen tank support for storing an oxygen tank thereon. The oxygen tank holder includes a support mount and a tank holder. The support mount is coupled with the frame for movement therewith. The tank holder is coupled with the support mount and configured to store the oxygen tank such that a longitudinal axis of the oxygen tank is positioned at an acute angle relative to horizontal.

In some embodiments of the second aspect, the patient support apparatus further includes a base and a lift assembly. The lift assembly is coupled to the base and the frame to move the frame vertically relative to the base.

In some embodiments of the second aspect, the oxygen tank support is coupled to a transverse side of the frame. In some embodiments of the second aspect, the oxygen tank support is coupled to a head end of the frame.

In some embodiments of the second aspect, the patient support apparatus further includes a deck coupled with the upper frame. The oxygen tank support is located within a footprint of the frame or the deck when viewed from above.

In some embodiments of the second aspect, the support mount includes a first mount arm coupled with the frame. The tank holder includes a sidewall coupled with the first mount arm and configured to extend at least partway around the oxygen tank and an end wall coupled with the sidewall and configured to engage a bottom of the oxygen tank.

In some embodiments of the second aspect, the support mount includes a second mount arm coupled with the frame. The sidewall is formed to include a first opening and a second opening. The first mount arm extends through the first opening and the second mount arm extends through the second opening.

In some embodiments of the second aspect, the frame includes a frame member and a first handle operably coupled to the frame member. The frame member is formed with a cutout configured to receive a top end of the oxygen tank.

According to a third aspect of the present disclosure, a patient support apparatus includes a base, an upper frame operably coupled with the base, a lift assembly, and an oxygen tank support. The lift assembly is coupled to the base and the upper frame to move the upper frame vertically relative to the base between a lowered position and a raised position. The oxygen tank support is operably coupled with the upper frame and has an adjustable height.

In some embodiments of the third aspect, the oxygen tank support includes a tank holder having an upper support coupled with the upper frame and a lower support movably coupled with the upper support. The lower support is configured to move relative to the upper support between a first position in which the tank holder has a first height and a second position in which the tank holder has a second height. In some embodiments of the third aspect, the lower support is configured to move relative to the upper support in response to movement of the upper frame between the raised position and the lowered position.

In some embodiments of the third aspect, the upper support is fixed with the upper frame and is formed to include a guide hole therein. The lower support includes an end wall for supporting a weight of the oxygen tank and a guide rail that extends away from the end wall and is received in the guide hole such that the lower support is slidingly engaged with the upper support.

In some embodiments of the third aspect, the lower support includes an end wall, a sidewall that extends away from the end wall, and a wheel. The wheel is coupled with the end wall for rolling on a floor underlying the patient support apparatus.

In some embodiments of the third aspect, the oxygen tank support is spaced apart from a floor underlying the patient support apparatus in response to the upper frame being in the raised position.

In some embodiments of the third aspect, the oxygen tank support further includes a height adjuster coupled with the lower support and the upper frame. The height adjuster is configured to move the lower support between the first position and the second position in response to the upper frame moving between the raised position and the lowered position.

In some embodiments of the third aspect, the height adjuster includes a cam unit and a cable. The cam unit is rotably coupled with the upper frame and the cable has a first end coupled to the cam unit and a second end coupled to the lower support.

In some embodiments of the third aspect, the cam unit further includes a cam arm and a link. The cam arm is rotably coupled with the upper frame. The link is coupled to the cam arm and to the base such that movement of the upper frame between the raised position and the lowered position causes the link to rotate the cam arm to actuate the cable.

In some embodiments of the third aspect, the lower support is coupled to the upper support for telescoping action relative to the upper support. In some embodiments of the third aspect, the height of the oxygen tank support varies in response to vertical movement of the upper frame.

A method of using a patient support apparatus in accordance with the third aspect includes moving an upper frame of the patient support apparatus relative to a floor underlying the patient support apparatus between a lowered position and a raised position, and varying a height of an oxygen tank support coupled with the upper frame.

In some embodiments of the third aspect, varying the height of the oxygen tank support is performed in response to the upper frame moving between the lowered position and the raised position. In some embodiments of the third aspect, varying the height of the oxygen tank support includes moving a lower support of a tank holder relative to an upper support of the tank holder that is coupled with the upper frame.

In some embodiments of the third aspect, the method further includes rotating a cam arm relative to the upper frame to cause the cam arm to move a cable coupled with the lower support of the tank holder to vary the height of the oxygen tank support.

In some embodiments of the third aspect, the method includes engaging a floor underlying the patient support apparatus with the lower support to cause the lower support to move relative to the upper support in response to the upper frame moving toward the lowered position.

According to a fourth aspect of the present disclosure, a patient support apparatus includes a base, an upper frame operably coupled with the base, a lift assembly, and an oxygen tank support. The lift assembly is coupled to the base and the upper frame to move the upper frame vertically relative to the base. The oxygen tank support is configured for storing an oxygen tank thereon. The oxygen tank support is operably coupled with the base and configured to be moved selectively to a plurality of positions relative to the base.

In some embodiments of the fourth aspect, the oxygen tank support includes a mount and a tank holder. The mount is pivotably coupled with the base and the tank holder is coupled with the mount for movement therewith.

In some embodiments of the fourth aspect, the mount includes a first segment and a second segment. The first segment is pivotably coupled with the base. The second segment is coupled with the tank holder and pivotably coupled with the first segment at a pivot joint.

In some embodiments of the fourth aspect, the mount includes a friction clutch to resist unintentional movement of the mount relative to the base. In some embodiments of the fourth aspect, the oxygen tank support further includes an IV pole coupler coupled with the mount and configured to couple the oxygen tank support with an IV pole. In some embodiments of the fourth aspect, the IV pole coupler includes a C-clamp.

In some embodiments of the fourth aspect, the oxygen tank support is movable between a stored position and a plurality of use positions. In the stored position, the oxygen tank support is located within a footprint of the upper frame when viewed vertically. In the plurality of use positions, the oxygen tank support is moved outside of the footprint.

A method of using a patient support apparatus in accordance with the fourth aspect includes moving an oxygen tank support from a stored position relative to a base of the patient support apparatus to a use position, and supporting an oxygen tank on the oxygen tank support.

In some embodiments of the fourth aspect, the method further includes coupling an IV pole with the oxygen tank support. In some embodiments of the fourth aspect, coupling the IV pole includes clamping the IV pole with the oxygen tank support.

In some embodiments of the fourth aspect, the method further includes moving the patient support apparatus relative to a floor underlying the patient support apparatus with the oxygen tank support in the use position. In some embodiments of the fourth aspect, moving the oxygen tank support includes pivoting a first segment and a second segment of a mount included in the oxygen tank support relative to the base.

In some embodiments of the fourth aspect, the method further includes rolling the IV pole along a floor underlying the patient support apparatus in response to movement of the patient support apparatus. In some embodiments of the fourth aspect, the method further includes moving the oxygen tank support from the use position to a second use position relative to the base.

According to a fifth aspect of the present disclosure, a patient support apparatus includes a base, and upper frame, a lift assembly, and an oxygen tank for storing an oxygen tank thereon. The upper frame is operably coupled with the base. The upper frame and the base defining a head end of the patient support apparatus and a foot end of the patient support apparatus connected by two longitudinal sides. The lift assembly is coupled to the base and the upper frame to move the upper frame vertically relative to the base.

The oxygen tank support is operably coupled via a swivel mount with the upper frame to rotate about a vertically oriented axis to allow the oxygen tank support to be moved selectively to a plurality of positions relative to the upper frame about the vertically oriented axis, such that the oxygen tank support can selectively extend from the head end of the patient support apparatus and from a longitudinal side of the patient support apparatus adjacent the head end. In some embodiments of the fifth aspect, the swivel mount is further configured to retain the oxygen tank support in at least one rotatable position.

According to a sixth aspect of the present disclosure, a patient support apparatus includes a base, an upper frame operably coupled with the base, a lift assembly, and an oxygen tank support for storing an oxygen tank thereon. The upper frame and base define a head end of the patient support apparatus and a foot end of the patient support apparatus and two longitudinal sides. The lift assembly is coupled to the base and the upper frame to move the upper frame vertically relative to the base. The oxygen tank holder includes a support mount and a tank holder. The support mount is coupled with the frame for movement therewith. The tank holder is coupled with the support mount and configured to store the oxygen tank such that a longitudinal axis of the oxygen tank is positioned at an acute angle relative to a horizontal axis along one of the longitudinal sides. In some embodiments of the sixth aspect, the acute angle is less than about 30 degrees relative to the horizontal axis.

According to a seventh aspect of the present disclosure, a patient apparatus includes a frame and an oxygen tank support. The frame is operable to move vertically relative to a floor underlying the frame. The oxygen tank support is coupled with the frame for storing an oxygen tank thereon. The oxygen tank support includes a tank holder and a support mount coupled the frame for movement therewith. The tank holder is configured to couple with the support mount in a first orientation of the tank holder and a second orientation of the tank holder.

In some embodiments, the tank holder is formed to define a first opening on a first side of the tank holder and a second opening on a second side of the tank holder. The support mount extends through each of the first opening and the second opening in both the first orientation and the second orientation of the tank holder.

In some embodiments, the support mount includes a first mount arm coupled with the frame. The first mount arm extends away from the frame and around at least a portion of the tank holder.

In some embodiments, the tank holder is formed to include a cavity that opens toward the frame and mouth that opens into the cavity on a lateral end of the tank holder. The mouth is located toward a first end of the frame in response to the tank holder being in the first orientation. The mouth is located toward a second end of the frame opposite the first end in response to the tank holder being in the second orientation.

In some embodiments, tank holder includes a sidewall extending between a first end and a second end of the tank holder and formed to define the cavity for receiving the oxygen tank therein and an end wall located at the first end of the oxygen tank holder and configured to engage a bottom of the oxygen tank. The support mount extends at least partway around the sidewall to couple the tank holder with the frame.

In some embodiments, the sidewall is formed to define a first opening. The support mount includes a first mount arm coupled with the frame and extending through the first opening and at least partway around the sidewall of the tank support.

In some embodiments, the sidewall is formed to define a second opening spaced apart from and opposite the first opening. The first mount arm extends through the second opening.

In some embodiments, the sidewall is formed to define a third opening spaced laterally apart from the first opening and a fourth opening spaced apart from and opposite the third opening. The support mount includes a second mount arm coupled with the frame and extending through the third opening and the fourth opening.

In some embodiments, the sidewall includes a curved segment that has a radius of curvature relative to an axis. The axis extends between 0 and 45 degrees relative to horizontal.

In some embodiments, the patient support apparatus includes a base and a lift assembly. The lift assembly is coupled to the base and the frame to move the frame vertically relative to the base.

In some embodiments, the oxygen tank support is coupled to a transverse side of the frame. In some embodiments, the oxygen tank support is coupled to a head end of the frame. In some embodiments, the tank holder is located within a footprint of the frame when viewed from above.

According to an eighth aspect of the disclosure, a method of assembling an oxygen tank support on a patient support apparatus includes aligning a first opening of a tank holder included in the oxygen tank support with a first mount arm of the oxygen tank support coupled with an upper frame of the patient support apparatus, and rotating the tank holder in a first direction relative to the first mount arm so that first mount arm extends through the first opening and then through a second opening of the tank holder after passing through the first opening to cause the tank holder to be supported on the first mount arm in a first orientation.

In some embodiments, the method includes rotating the tank holder in a second direction relative to the first mount arm so that the first mount arm is removed from the first opening and the second opening. The method may include aligning the second opening of the tank holder included in the oxygen tank support with the first mount arm. The method may include rotating the tank holder in the first direction relative to the first mount arm so that first mount arm extends through the second opening and then through the first opening of the tank holder after passing through the second opening to cause the tank holder to be supported on the first mount arm in a second orientation.

In some embodiments, the method includes aligning a third opening of the tank holder with a second mount arm of the oxygen tank support coupled with the upper frame of the patient support apparatus and spaced apart from the first mount arm. Rotating the tank holder in the first direction relative to the first mount arm may cause the second mount arm to extend through the third opening and then through a fourth opening of the tank holder after passing through the third opening to cause the tank holder to be supported on the second mount arm in the first orientation.

In some embodiments, the method includes locating an anti-rotation tab that extends from a body of the tank holder into a recess formed in the first mount arm.

In some embodiments, the method includes coupling the first mount arm with the upper frame prior to aligning the first opening of the tank holder included in the oxygen tank support with the first mount arm. The first mount arm may be rigid and include a first segment that extends downwardly away from the upper frame and a second segment that is curved to provide a channel with an opening facing the upper frame.

Additional features, which alone or in combination with any other feature(s), such as those listed above and/or those listed in the claims, can comprise patentable subject matter and will become apparent to those skilled in the art upon consideration of the following detailed description of various embodiments exemplifying the best mode of carrying out the embodiments as presently perceived.

### BRIEF DESCRIPTION OF THE DRAWINGS

The detailed description particularly refers to the accompanying figures in which:

FIG. 1 is a perspective view of a first embodiment of a patient support apparatus according to the present disclosure having a movable oxygen tank support in a first position;

FIG. 2A is a top perspective view of the patient support apparatus of FIG. 1 with the oxygen tank support moved to a second position;

FIG. 2B is an enlarged top perspective view of a portion of the head end of the patient support apparatus of FIG. 2;

FIG. 3 is a perspective view of another embodiment of a patient support apparatus having a movable oxygen tank support;

FIG. 4 is a perspective view of another embodiment of a patient support apparatus having a movable oxygen tank support;

FIG. 5 is a perspective view of another embodiment of a patient support apparatus having an oxygen tank support stored on a side of the patient support apparatus;

FIG. 6 is a top view of a head end of the patient support apparatus of FIG. 5;

FIG. 7 is a perspective view of a head end of another embodiment of a patient support apparatus having an oxygen tank support stored on a side of the patient support apparatus;

FIG. 8 is a perspective view of a head end of another embodiment of a patient support apparatus having an oxygen tank support stored at a front of the head end of the patient support apparatus;

FIG. 9 is a perspective view of a head end of another embodiment of a patient support apparatus having an oxygen tank support stored at a front of the head end of the patient support apparatus;

FIG. 10 is a perspective view similar to FIG. 9 showing an oxygen tank stored in the oxygen tank support;

FIG. 11 is an elevation view of another embodiment of a patient support apparatus having an adjustable height oxygen tank support showing the patient support apparatus in a lowered position;

FIG. 12 is an elevation view of the patient support apparatus of FIG. 11 showing the patient support apparatus in a raised position;

FIG. 13 is a perspective view of the patient support apparatus of FIG. 11 with a model oxygen tank supported in the adjustable height oxygen tank support;

FIG. 14 is a perspective view of the patient support apparatus of FIG. 12 with the model oxygen tank supported in the adjustable height oxygen tank support;

FIG. 15 is an elevation view of another embodiment of a patient support apparatus having an adjustable height oxygen tank support showing the patient support apparatus in a lowered position;

FIG. 16 is an elevation view of the patient support apparatus of FIG. 15 showing the patient support apparatus in a raised position;

FIG. 17 is a perspective view of a head end of another embodiment of a patient support apparatus having a movable oxygen tank support in a stored position;

FIG. 18 is a perspective view of the head end of the patient support apparatus of FIG. 17 with the oxygen tank support in a use position;

FIG. 19 is a perspective view of the head end of the patient support apparatus of FIG. 18 with an oxygen tank stored in the oxygen tank support;

FIG. 20 is a perspective view of the head end of the patient support apparatus of FIG. 18 with an oxygen tank stored in the oxygen tank support and a rolling intravenous (IV) pole coupled with the oxygen tank support;

FIG. 21 is a perspective view of the head end of the patient support apparatus of FIG. 20 with the oxygen tank support in another use position;

FIG. 22 is a perspective view of a head end of a patient support apparatus having another embodiment of an oxygen tank support that is repositionable between orientations with the oxygen tank support in a first orientation configured to locate the valve end of the oxygen tank on a first side of the patient support apparatus;

FIG. 23 is a perspective view of the head end of the patient support apparatus of FIG. 22 with the repositionable oxygen tank support in a second orientation configured to locate the valve end of the oxygen tank on a second side of the patient support apparatus such that the caregiver is allowed to easily reposition the oxygen tank support to locate the valve end of the oxygen tank on a desired side of the patient support apparatus;

FIG. 24 is an exploded view of the oxygen tank support of FIG. 22, the oxygen tank support having an oxygen tank holder and a support mount having two mount arms for coupling the oxygen tank holder to a frame of the patient support apparatus;

FIG. 25 is a front view of the oxygen tank holder included in the oxygen tank support of FIG. 22;

FIG. 26 is a top elevation view of the oxygen tank holder included in the oxygen tank support of FIG. 22;

FIG. 27 is a bottom elevation view of the oxygen tank holder included in the oxygen tank support of FIG. 22;

FIG. 28 is a side elevation view of the oxygen tank holder included in the oxygen tank support of FIG. 22;

FIG. 29 is a section view of the oxygen tank holder of FIG. 22 taken through line 29-29 of FIG. 23;

FIG. 30 is a perspective view of the patient support apparatus of FIG. 22 with the oxygen tank holder arranged for installation onto the support mount in the first orientation, the oxygen tank holder being generally upside down so that first openings on a first side of the oxygen tank holder are aligned with the mount arms of the support mount;

FIG. 31 is a perspective view of the patient support apparatus similar to FIG. 30 with the oxygen tank holder rotated so that mount arms are in the openings of the oxygen tank holder and second openings on a second side of the oxygen tank holder are moved toward alignment with and for receiving the mount arms of the support mount;

FIG. 32 is a perspective view of the patient support apparatus similar to FIG. 31 with the oxygen tank holder fully rotated into the first orientation so that an oxygen tank supported by the oxygen tank holder has its valve end located on the first side of the patient support apparatus;

FIG. 33 is a perspective view of the patient support apparatus of FIG. 22 with the oxygen tank holder arranged for installation onto the support mount in the second orientation, the oxygen tank holder being generally upside down so that the second openings on the second side of the oxygen tank holder are aligned with the mount arms of the support mount;

FIG. 34 is a perspective view of the patient support apparatus similar to FIG. 33 with the oxygen tank holder rotated so that mount arms are in second openings of the oxygen tank holder and the first openings on the first side of the oxygen tank holder are moved toward alignment with and for receiving the mount arms of the support mount; and

FIG. 35 is a perspective view of the patient support apparatus similar to FIG. 31 with the oxygen tank holder fully rotated into the second orientation so that an oxygen tank supported by the oxygen tank holder has its valve end located on the second side of the patient support apparatus.

### DETAILED DESCRIPTION

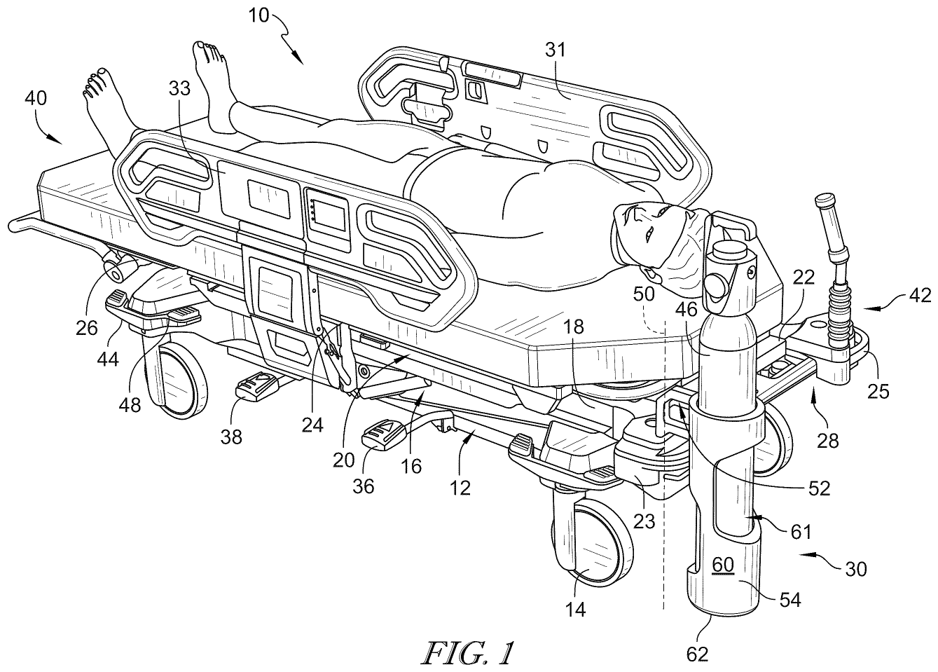

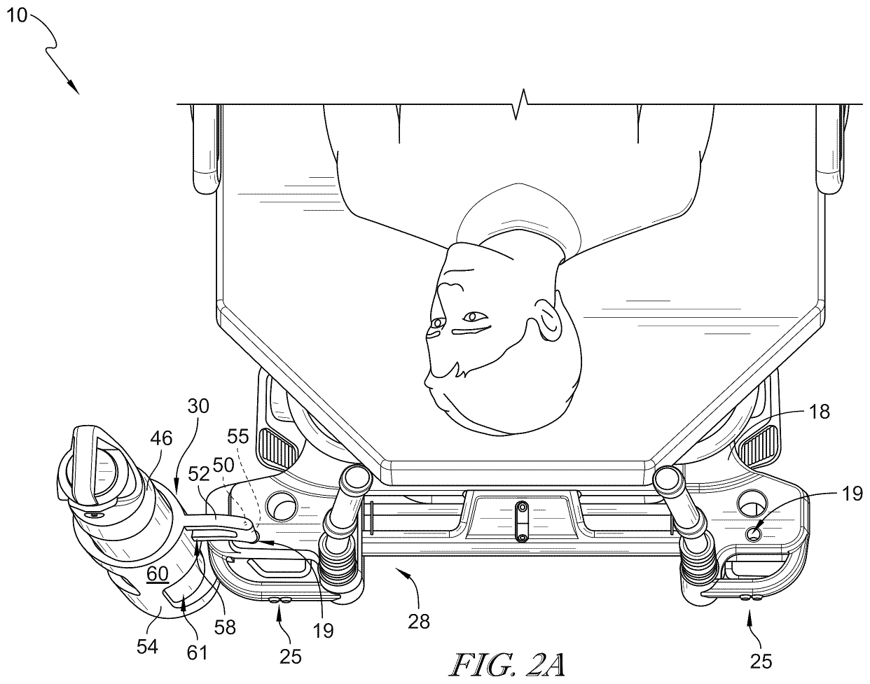

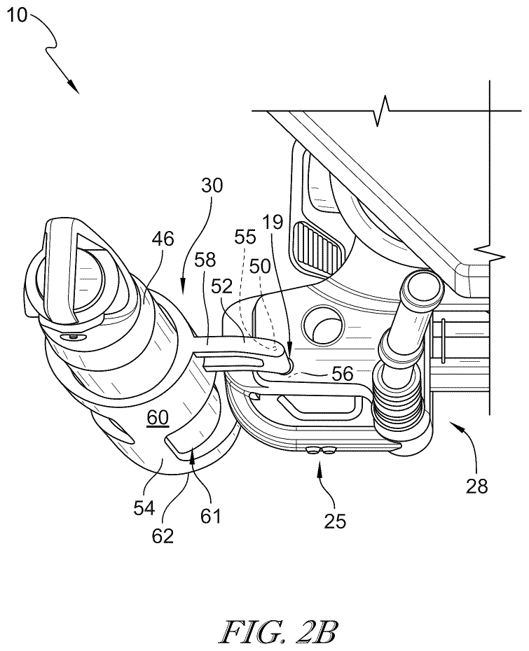

According to the present disclosure, a patient support apparatus 10 shown in FIGS. 1-2B and embodied as a stretcher is configurable to provide care to patients of varying acuity, while also providing improved mobility as a patient is moved between areas of a care facility, such as a hospital, for example. The patient support apparatus 10 includes a base 12 supported on four casters 14 which are lockable to prevent movement of the patient support apparatus 10 over the floor, but are oversized to provide smooth movement over the floor when released. The base 12 supports a lift assembly 16 which provides support of an upper frame 18 and moves the upper frame 18 vertically when the lift assembly 16 is activated between a raised position and a lowered position. In the illustrative embodiment, the upper frame 18 is cantilevered on the lift assembly 16. In other embodiments, the lift assembly 16 may include one or multiple telescoping columns, scissor lift arms, or other suitable mechanisms for lifting the upper frame 18 relative to the base 12. In other embodiments, the patient support apparatus 10 is embodied as a hospital bed or table such as an operating table. In some embodiments, the patient support apparatus 10 is coupled to a floor underlying the upper frame 18 and the lift assembly 16 is coupled with the floor.

A caregiver may be located near a head end 42 of the upper frame 18 when administering care and treatment to a patient supported on the patient support apparatus 10. With a conventional patient support apparatus, an oxygen tank support may be coupled to the upper frame near the head end 42 to store an oxygen tank vertically in a fixed position near the patient's head to provide the caregiver access to the oxygen tank. In other conventional patient support apparatuses, the oxygen tank support may be located between the upper frame and the base within a footprint of the upper frame. However, such conventional oxygen tank supports may obstruct the caregiver's access to the patient or may cause a minimum height of the upper frame relative to the floor to be greater than desired when the upper frame is in a lowered position.

According to the present disclosure, the patient support apparatus 10 includes an oxygen tank support 30 that is movably coupled with the upper frame 18 of the patient support apparatus 10 to allow the oxygen tank support 30 to be moved selectively to grant improved caregiver access to the patient. According to some aspects of the present disclosure, oxygen tank supports 30, 230, 330, 430, 530, 630, 730, 830, 930, 1030, 1130 are coupled with the base or the upper frame of a patient support apparatus 10, 210, 310, 410, 510, 610, 710, 810, 910, 1010, 1110 in locations and orientations that provide improved caregiver access to the patient for treatment or for transfer to another patient support surface.

The oxygen tank supports 30, 230, 330, 430, 530, 630, 730, 830, 930, 1030, 1130 of the present disclosure may allow for additional clearance between the oxygen tank support 30, 230, 330, 430, 530, 630, 730, 830, 930, 1030, 1130 and the floor underlying the patient support apparatus 10, 210, 310, 410, 510, 610, 710, 810, 910, 1010, 1110 as compared to conventional oxygen tank storage arrangements. As an example, the oxygen tank supports 30, 230, 330, 430, 530, 630, 730, 830, 930, 1030, 1130 of the present disclosure may avoid interference with the base or the floor to allow a height of the upper frame relative to the floor to be minimized when the upper frame is in a lowered position. The oxygen tank supports 30, 230, 330, 430, 530, 630, 730, 830, 930, 1030, 1130 of the present disclosure may allow for Trendelenburg position and reverse Trendelenburg position of the upper frame when the upper frame is in the raised position.

The upper frame 18 of the illustrative patient support apparatus 10 supports a patient deck 20 as shown in FIG. 1. The patient deck 20 has multiple sections and, in illustrative embodiments, has panels that are constructed of radiolucent material so that a C-arm x-ray device or other similar imaging devices may be used with the patient deck 20. The patient deck 20 has a pivoting head deck section 22 that pivots or moves relative to the upper frame 18. A thigh deck section 24 is also pivotable relative to the upper frame 18. A calf deck section 26 is supported from the upper frame 18 and pivotable relative to the thigh deck section 24. The calf deck section 26 is configured to move to a dependent position wherein the foot end 40 of the calf deck section 26 drops below the upper frame 18 so that the patient deck 20 may form a chair-like arrangement for patient comfort and optimal positioning.

In the embodiment of FIGS. 1-2B, the articulation of the calf deck section 26 and thigh deck section 24 is accomplished via an electric actuator. The same is true of the head deck section 22. The articulation may be assisted by a releasable gas spring, which provides some force to assist in the movement of the sections when they are being manipulated. In some embodiments, the articulation may be manually manipulated by a caregiver without the assistance of the electric actuator.

To assist with the mobility of the patient support apparatus 10, push handles 28 are positioned at a head end 42 of the patient support apparatus 10. The push handles 28 in the embodiment of FIG. 1 are coupled to the upper frame 18 and the height of the push handles 28 is adjusted by adjusting the height of the upper frame 18 using the lift assembly 16. The patient support apparatus 10 further includes a right-siderail 31 and a left-siderail 33. The orientation of the sides and ends of the patient support apparatus 10 is established by the orientation of a patient supported on the patient support apparatus 10 in a supine position such that the right-siderail 31 is positioned to the patient's right and the left-siderail 33 is positioned to the patient's left. Similarly, references to calf deck section 26 or foot end 40 related to the position of the patient's feet when in the supine position on the patient support apparatus 10. Likewise, the head end 42 is oriented at the end of the patient support apparatus 10 where a patient's head would be in a supine position.

The lift assembly 16 is operated by a raise pedal 36 that may allow a user to manually activate the raise pedal 36 so that the lift assembly 16 is raised. In some embodiments, the raise pedal 36 may require multiple activations to move the lift assembly 16, but in other embodiments, the lift assembly 16 may be powered to actuate with a single activation of the raise pedal 36. A lower pedal 38 is actuable to cause the lift assembly 16 to lower, thereby lowering the upper frame 18.

The patient support apparatus 10 includes a brake/steer mechanism supported by the base 12. The brake/steer mechanism is of the type known in the art and able to transition the operation of the casters 14 between a full lock that prevents rotation of the wheels of the caster 14 and prevents swiveling of the caster 14 about a vertical axis, a neutral position in which the casters 14 are free to rotate and swivel, and a steer position in which at least one of the casters 14 is locked in swivel to serve as a tracking wheel to assist with steering of the patient support apparatus 10. In the present embodiment, the caster 14 positioned at the left foot end of the patient support apparatus 10 serves as the steer caster. In other embodiments, a different caster 14 may be placed in steer. The activation of the brake/steer mechanism is provided by an actuator which is positioned at each caster 14, each actuator having a brake pedal 44 and a steer pedal 48 as is known in the art. This allows a caregiver to actuate the brake/steer mechanism at multiple positions about the periphery of the patient support apparatus 10.

Notably, the patient support apparatus 10 further includes the oxygen tank support 30 that supports the oxygen tank 46 as shown in FIGS. 1 and 2A. The oxygen tank support 30 is rotatably coupled with the upper frame 18 to allow the oxygen tank 46 to be pivoted by the caregiver to a plurality of positions relative to the upper frame 18 to increase access to the patient depending on the position of the caregiver and therapies being applied. The oxygen tank support 30 is rotatable between a first position shown in FIG. 1, a second position shown in FIG. 2A, and a plurality of positions therebetween. The angle between the first position and the second position may be about 45 degrees, 90 degrees, 180 degrees, 225 degrees, 270 degrees, or any angle between 0 and 360 degrees. In the illustratively embodiment, the oxygen tank support 30 is infinitely and continuously adjustable between the first position and the second position.

The oxygen tank support 30 includes a swivel mount 52 and a tank holder 54 as shown in FIGS. 1-2A. The swivel mount 52 is rotatably coupled with the upper frame 18 to rotate about an axis 50 that extends vertically through the upper frame 18 as suggested in FIGS. 1-2B. The tank holder 54 is coupled with the swivel mount 52 for movement therewith and is configured to receive the oxygen tank 46 to hold the oxygen tank 46 with the oxygen tank support 30. In particular, the tank holder 54 rotates about a perimeter edge of the upper frame 18. The oxygen tank support 30 may be rotated to different positions to provide the caregiver greater access to the patient or to be moved out of the way when transferring the patient to another support surface. For example, the oxygen tank support 30 may be rotated to another position or moved from one side of the upper frame 18 to the other side.

Illustratively, the swivel mount 52 includes a first end 56 that extends vertically into a hole 19 formed in the upper frame 18 and a second end 58 that extends away from the first end 56 and coupled to the tank holder 54 as suggested in FIGS. 2A and 2B. The swivel mount 52 may include a release lock 55 that engages the upper frame 18 to block inadvertent separation of the swivel mount 52 from the upper frame 18. The release lock 55 may include a thumb release button, handle, or other device that can be activated by the caregiver to disengage the release lock 55 to allow the swivel mount 52, and oxygen tank support 30, to be separated from the upper frame 18. For example, the swivel mount 52 may be lifted vertically upward out of the hole 19 and then moved away from the upper frame 18.

The tank holder 54 includes a sidewall 60 that extends around the oxygen tank 46 to retain the oxygen tank 46 in place and an end wall 62 coupled with the sidewall 60 to support a bottom of the oxygen tank 46. In the illustrative embodiment, the swivel mount 52 is coupled with the sidewall 60 and the sidewall 60 is solid with cutouts 61 that expose portions of the oxygen tank 46. The tank holder 54 is sized and coupled with the swivel mount 52 such that the end wall 62 is spaced apart from the floor underyling the patient support apparatus 10 when the upper frame 18 is in the lowered position as suggested in FIG. 1.

As shown in FIG. 2B, the upper frame 18 further includes a frame member 23, such as a rail, accessory support structure, handle, etc. and support retainer 25 configured to maintain, selectively, the oxygen tank support 30 in a predetermine position. The oxygen tank support 30 can be engaged by the support retainer 25 so that the oxygen tank support 30 is resisted from rotating about the axis 50. This may be desired when moving the patient support apparatus through a hallway as an example. A minimal force can be applied to the oxygen tank support 30 to disengage the support retainer 25 and allow the oxygen tank support 30 to rotate about the axis 50. As a result, the support retainer 25 provides a convenient option to store the oxygen tank support 30 in a predetermined position while also allowing the caregiver to move the oxygen tank support 30 to another position with minimal effort. The support retainer 25 may be configured to engage the swivel mount 52 or the tank holder 54 in various embodiments.

The support retainer 25 includes a pair of tabs 25 that extend away from the frame member 23 in the present embodiment as shown in FIG. 2B. The tabs 25 form a gap therebetween that receive a portion of the sidewall 60 of the tank holder 54 included in the oxygen tank support 30. The tabs 25 are configured to engage the portion of the sidewall 60 to block rotation of the oxygen tank support 30. In other embodiments, the support retainer 25 includes detents or other suitable alternatives for blocking rotation of the oxygen tank support 30 while providing minimal rotational resistance when the caregiver desires to rotate the oxygen tank support 30 away from that position. In some embodiments, multiple support retainers 25 are present to provide multiple predetermined positions to hold, selectively, the oxygen tank support 30 relative to the axis 50.

The upper frame 18 includes two holes 19, one on the left side of the patient support apparatus 10 and one on the right side as shown in FIG. 2A, for receiving the oxygen tank support 30. The holes 19 are sized to receive IV poles in the present embodiment. The holes are formed in the frame member 23 of the upper frame 18 which supports handles and levers for manipulating the patient support apparatus.

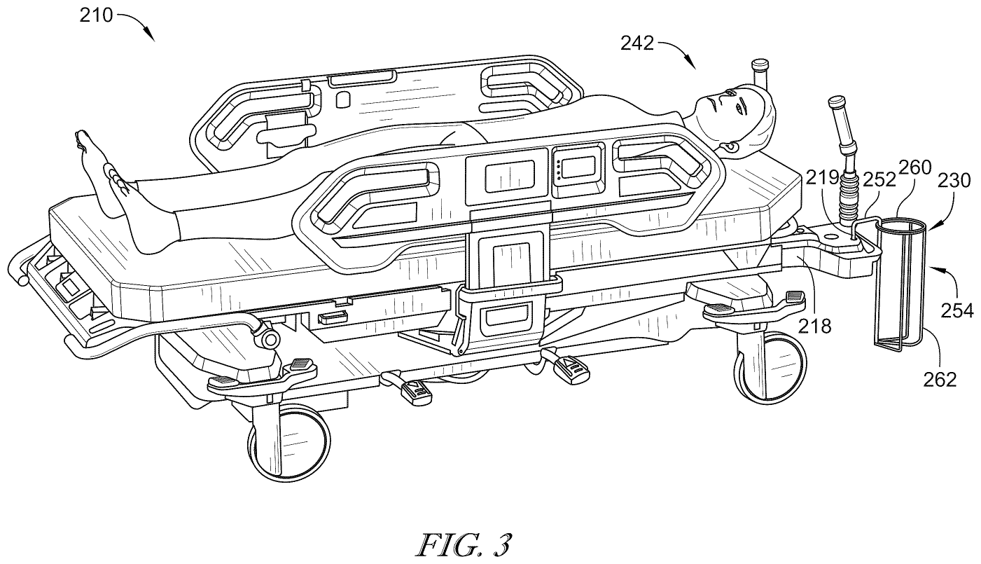

Referring now to FIG. 3, another embodiment of a patient support apparatus 210 is similar to the embodiment in FIGS. 1-2B. The patient support apparatus 210 includes an oxygen tank support 230 coupled with an upper frame 218 of the patient support apparatus 210. The oxygen tank support 230 is similar to the oxygen tank support 30 except as otherwise described herein. The oxygen tank support 230 includes a swivel mount 252 and a tank holder 254 as shown in FIG. 3. The swivel mount 252 includes a rod having a first end that extends into a hole 219 in the upper frame 218 and curves toward the floor to a second end. The tank holder 254 includes a band 260 coupled with the swivel mount 252 and a plurality of rails 262 that extend downwardly away from the band 260 to support a sidewall and bottom of the oxygen tank 46.

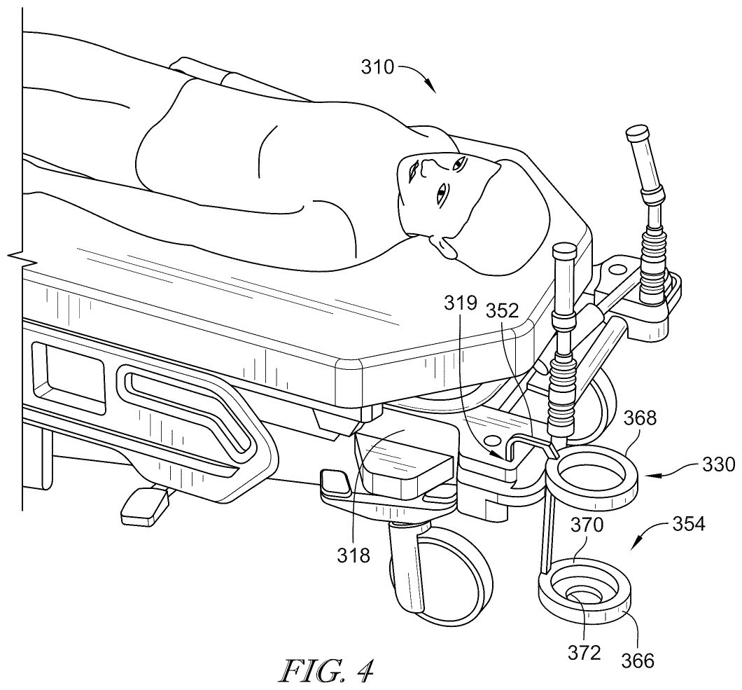

Referring now to FIG. 4, another embodiment of a patient support apparatus 310 is similar to the embodiment in FIGS. 1-2B. The patient support apparatus 310 includes an oxygen tank support 330 coupled with an upper frame 318 of the patient support apparatus 310. The oxygen tank support 330 is similar to the oxygen tank support 30 except as otherwise described herein. The oxygen tank support 330 includes a swivel mount 352 and a tank holder 354 as shown in FIG. 4. The swivel mount 352 includes a rod having a first end that extends into a hole 319 in the upper frame 318 and curves toward the floor to a second end thereof. The tank holder 354 includes a first band 366 coupled with the swivel mount 352 and formed to support a bottom of the oxygen tank 46 and a second band 368 spaced apart vertically from the first band and coupled with the swivel mount 352. The first band 366 and the second band 368 are sized to extend around a circumference of the oxygen tank 46. The first band 366 includes a lip 370 that extends circumferentially around the oxygen tank 46 and a bottom 372 that extends partway or fully inwardly away from the lip 370 to engage a bottom of the oxygen tank 46.

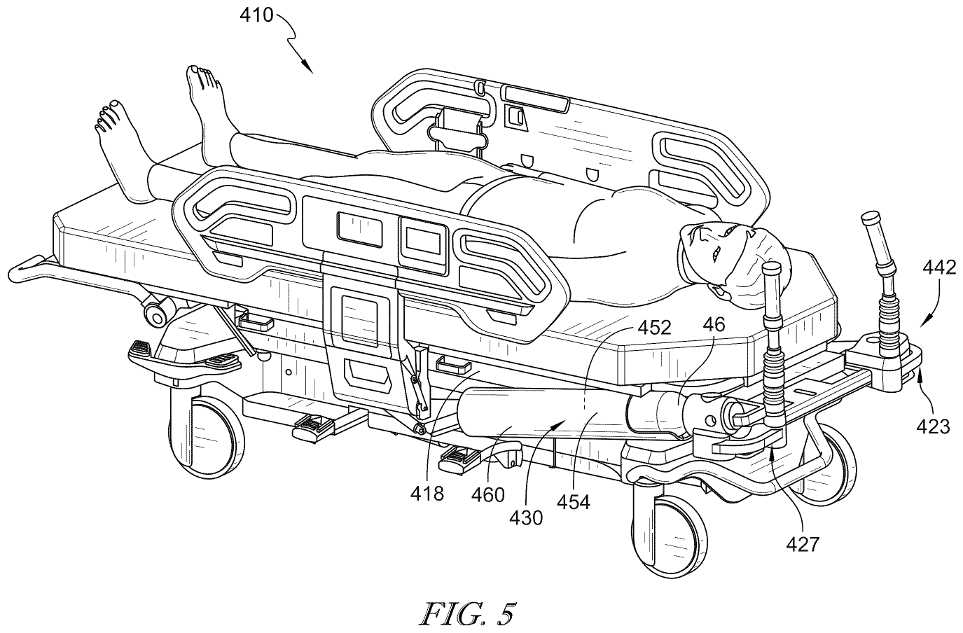

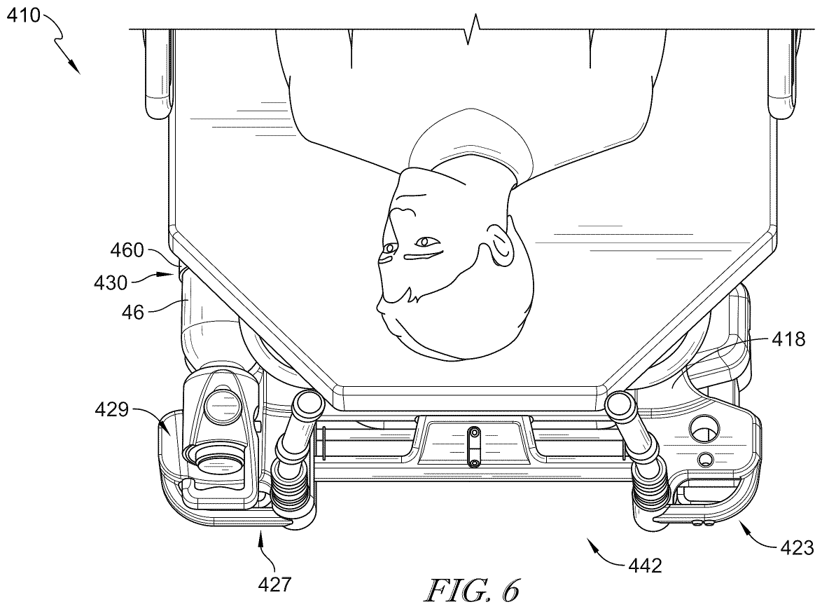

Referring now to FIGS. 5 and 6, another embodiment of a patient support apparatus 410 is similar to the embodiment in FIGS. 1-2B. The patient support apparatus 410 includes an oxygen tank support 430 coupled with an upper frame 418 of the patient support apparatus 410. The oxygen tank support 430 is coupled to a lateral side of the upper frame 418 to provide caregiver access to the oxygen tank 46 stored thereon near a head end 442 of the upper frame 418. The oxygen tank support 430 includes a support mount 452 and a tank holder 454 coupled with the support mount 452. The support mount 452 may be fixed to the upper frame 418 via welding or fasteners. The tank holder 454 includes a sidewall 460 that extends at least partway about the oxygen tank 46 and an end wall 362 that is configured to engage a bottom of the oxygen tank 46 to block the oxygen tank 46 from separating from the oxygen tank support 430. The sidewall 460 extends entirely around the oxygen tank 46 with an opening to receive the oxygen tank 46 therein.

The oxygen tank support 430 is arranged to orient the oxygen tank 46 generally horizontal at angle between 0 and 45 degrees relative to ground in the illustrative embodiment. The oxygen tank support 430 locates the oxygen tank 46 within a lateral footprint of the upper frame 418 or a deck coupled to the upper frame 418 as suggested in FIG. 6 such that the oxygen tank support 430 and oxygen tank 46 do not increase a width of the patient support apparatus 410 in the illustrative embodiment.

Illustratively, the upper frame 418 includes a first accessory support structure 423 and a second accessory support structure 427 as shown in FIG. 6. The first accessory support structure 423 is substantially similar to the accessory support structures in FIGS. 1-2B and supports a handle and levers for manipulating the patient support apparatus 410. The second accessory support structure 427 is formed with a recess 429 to receive and support a top of the oxygen tank 46 as shown in FIG. 6. The oxygen tank 46 does not extend longitudinally beyond a perimeter of the second accessory support structure 427 in the illustrative embodiment.

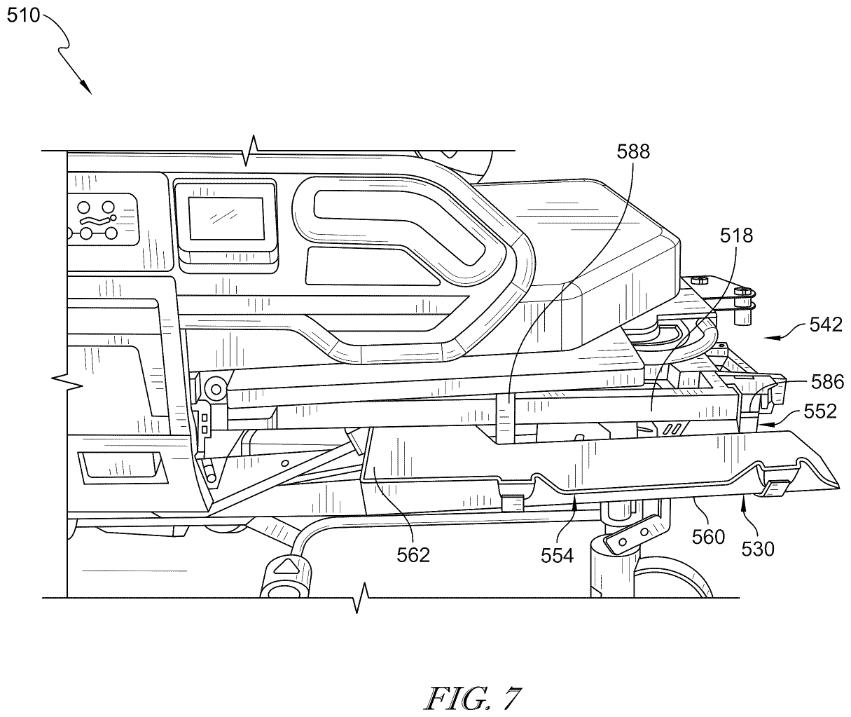

Referring now to FIG. 7, another embodiment of a patient support apparatus 510 is similar to the embodiment in FIGS. 5-6. The patient support apparatus 510 includes an oxygen tank support 530 coupled with an upper frame 518 of the patient support apparatus 510. The oxygen tank support 530 is similar to the oxygen tank support 430 except as otherwise described herein. The oxygen tank support 530 is coupled to a lateral side of the upper frame 518 to provide caregiver access to the oxygen tank 46 stored thereon near a head end 542 of the upper frame 518. The oxygen tank support 530 includes a support mount 552 and a tank holder 554 coupled with the support mount 552. The support mount 552 may be fixed to the upper frame 518 via welding or fasteners. The tank holder 554 includes a sidewall 560 that extends at least partway about the oxygen tank 46 and an end wall 562 that is configured to engage a bottom of the oxygen tank 46 to block the oxygen tank 46 from separating from the oxygen tank support 530.

The support mount 552 includes a first mount arm 586 and a second mart arm 588 spaced apart from the first mount arm 586 as shown in FIG. 7. Each of the first mount arm 586 and the second mount arm 588 extend from a first end coupled with the upper frame 518 and around the sidewall 560 of the tank holder 554 to a second end thereof to couple the tank holder 554 with the upper frame 518. The sidewall 560 and the end wall 562 each extend partway along the oxygen tank 46.

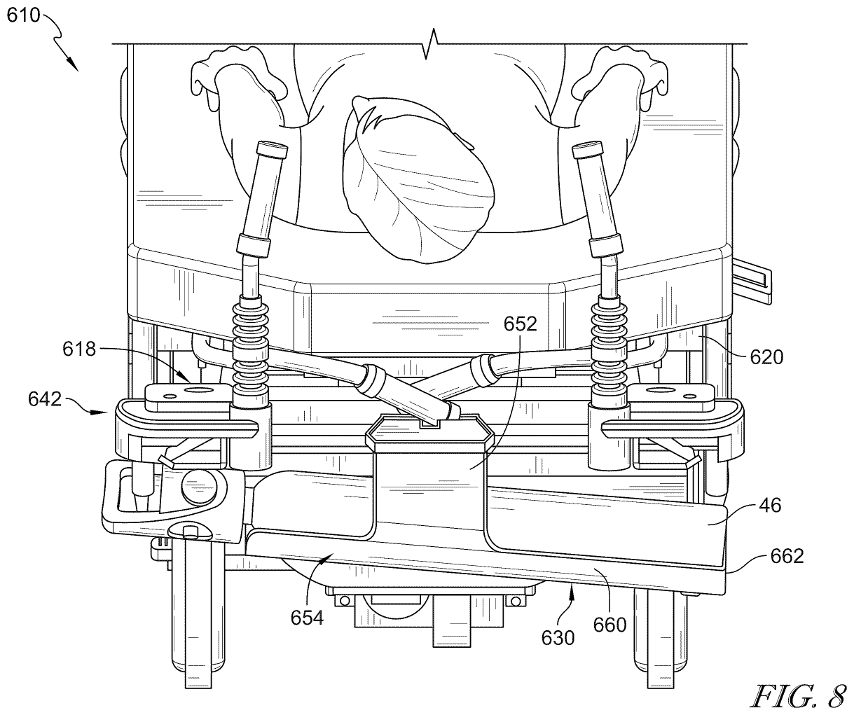

Referring now to FIG. 8, another embodiment of a patient support apparatus 610 is similar to the embodiments in FIGS. 5-7. The patient support apparatus 610 includes an oxygen tank support 630 coupled with an upper frame 618 of the patient support apparatus 610. The oxygen tank support 630 is coupled to a head end 642 of the upper frame 618 to provide caregiver access to the oxygen tank 46 stored thereon near the head end 642 of the upper frame 618. The oxygen tank support 630 includes a support mount 652 and a tank holder 654 coupled with the support mount 652. The support mount 652 may be fixed to the upper frame 618 via welding or fasteners. The tank holder 654 includes a sidewall 660 that extends at least partway about the oxygen tank 46 and an end wall 662 that is configured to engage a bottom of the oxygen tank 46 to block the oxygen tank 46 from separating from the oxygen tank support 630. The sidewall 660 extends entirely around the oxygen tank 46 with an opening to receive the oxygen tank 46 therein. 610.

The support mount 652 includes a mount arm 366 as shown in FIG. 8. The mount arm 366 extend from a first end coupled with the upper frame 618 to a second end thereof to couple to the sidewall 660 of the tank holder 654. The sidewall 660 and the end wall 662 each extend partway along the oxygen tank 46.

The oxygen tank support 630 is arranged to orient the oxygen tank 46 generally horizontal at an acute angle, less than 90 degrees and including 0 degrees. The angle is between 0 and 45 degrees relative to ground in the illustrative embodiment. In some embodiments, the oxygen tank support 630 locates the oxygen tank 46 within a lateral footprint of the upper frame 618 or a deck 620 supported on the upper frame 618 as suggested in FIG. 8 such that the oxygen tank support 630 and oxygen tank 46 do not increase a width of the patient support apparatus 610. The oxygen tank support 630 remains spaced apart from the floor when the patient support apparatus 610 is in the lowered position. The oxygen tank support 630 allows for Trendelenburg position and reverse Trendelenburg position when the upper frame 618 is in the raised position. As such, the movement envelope of the patient support apparatus 610 is unchanged with the inclusion of the oxygen tank support 630.

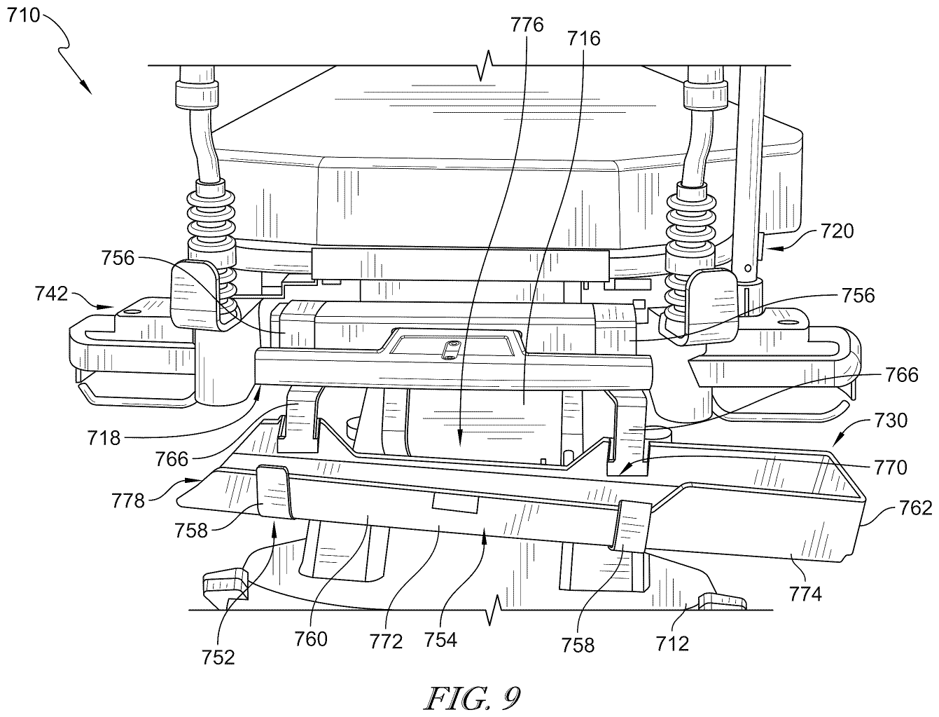

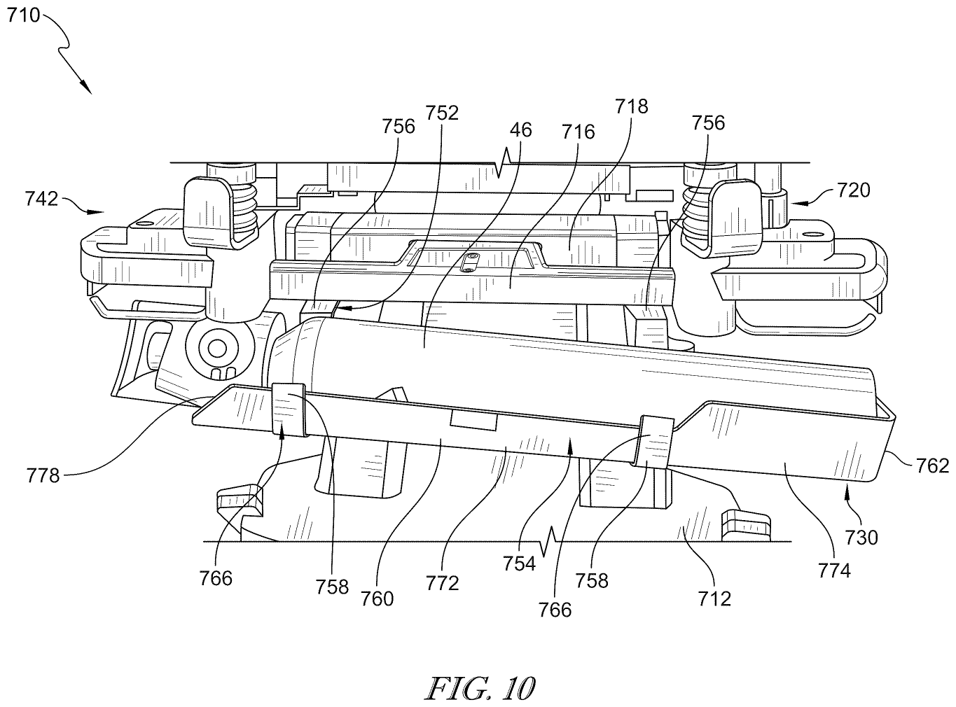

Referring now to FIGS. 9-10, another embodiment of a patient support apparatus 710 is similar to the embodiment in FIG. 8. The patient support apparatus 710 includes an oxygen tank support 730 coupled with an upper frame 718 of the patient support apparatus 710. The oxygen tank support 730 is coupled to a head end 742 of the upper frame 718 to provide caregiver access to the oxygen tank 46 stored thereon near the head end 742 of the upper frame 718. The oxygen tank support 730 includes a support mount 752 and a tank holder 754 coupled with the support mount 752. The support mount 752 may be fixed to the upper frame 718 via welding or fasteners. The tank holder 754 includes a sidewall 760 that extends at least partway about the oxygen tank 46 and an end wall 762 that is configured to engage a bottom of the oxygen tank 46 to block the oxygen tank 46 from separating from the oxygen tank support 730.

The support mount 752 includes a plurality of mount arms 766 as shown in FIG. 9. In the illustrative embodiment, the support mount 752 includes two mount arms 766 spaced apart from one another in a lateral direction. The mount arms 766 each extend from a first end 756 coupled with the upper frame 718 to a second end 758 thereof to couple to the sidewall 760 of the tank holder 754. The first end 756 of each mount arm 766 extends outward away from a head end 742 of the upper frame 718 and then curves with an arcuate shape down and around a first side of the tank holder 754 and terminates at the send end 758 of the mount arm 766 located at a second side of the tank holder 754.

The sidewall 760 of the tank holder 754 extends partway around the oxygen tank 46 to form a large opening to receive the oxygen tank 46 therein. The sidewall 760 and the end wall 762 each extend partway along the oxygen tank 46. The sidewall 760 is formed to include openings 770 and the mount arms 766 each extend through a corresponding opening 770 as shown in FIG. 9. The sidewall 760 includes a first segment 772 that extends circumferentially about an axis of the tank holder 754 a first distance. The sidewall 760 includes a second segment 774 that extends circumferentially about the axis of the tank holder 754 a second distance that is greater than the first distance. The end wall is coupled with the second segment 774. The first segment 772 includes a cutout 776 shaped to receive a portion of a base 712 or lift assembly 716 of the patient support apparatus 710. The first segment 772 is formed with a tapered terminal end 778 to increase access to a valve of the oxygen tank 46 as suggested in FIGS. 9 and 10.

The oxygen tank support 730 is arranged to orient the oxygen tank 46 generally horizontal at angle between 0 and 45 degrees relative to ground in the illustrative embodiment. In some embodiments, the oxygen tank support 730 locates the oxygen tank 46 within a lateral footprint of the upper frame 718 or a support surface of a deck 720 on the upper frame 718 as suggested in FIG. 10 such that the oxygen tank support 730 and oxygen tank 46 do not increase a width of the patient support apparatus 710. The oxygen tank support 730 remains spaced apart from the floor when the patient support apparatus 710 is in the lowered position. The oxygen tank support 730 allows for Trendelenburg position and reverse Trendelenburg position when the upper frame 718 is in the raised position. As such, the movement envelope of the patient support apparatus 710 is unchanged with the inclusion of the oxygen tank support 730.

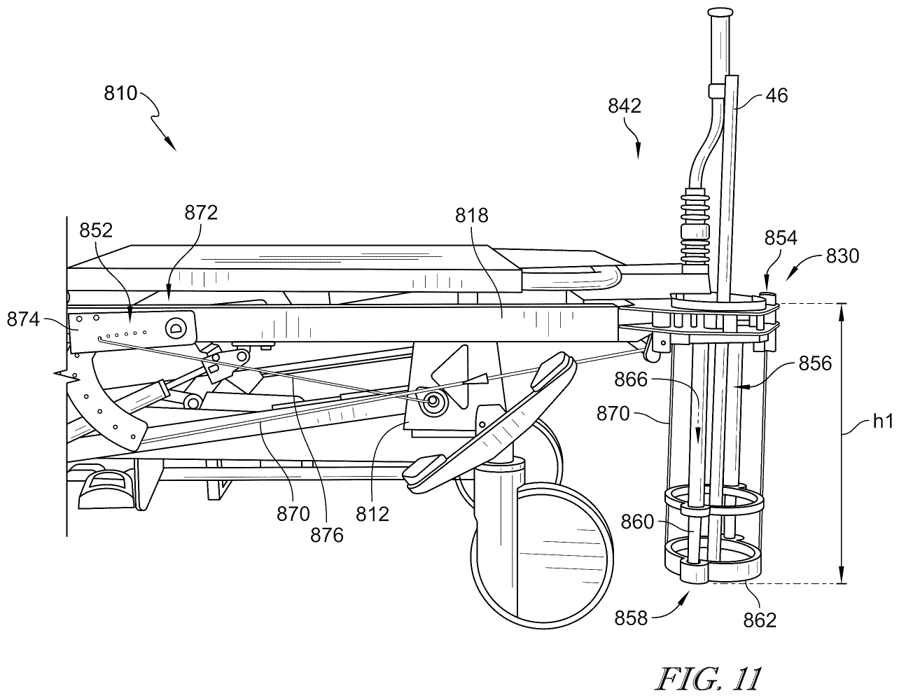

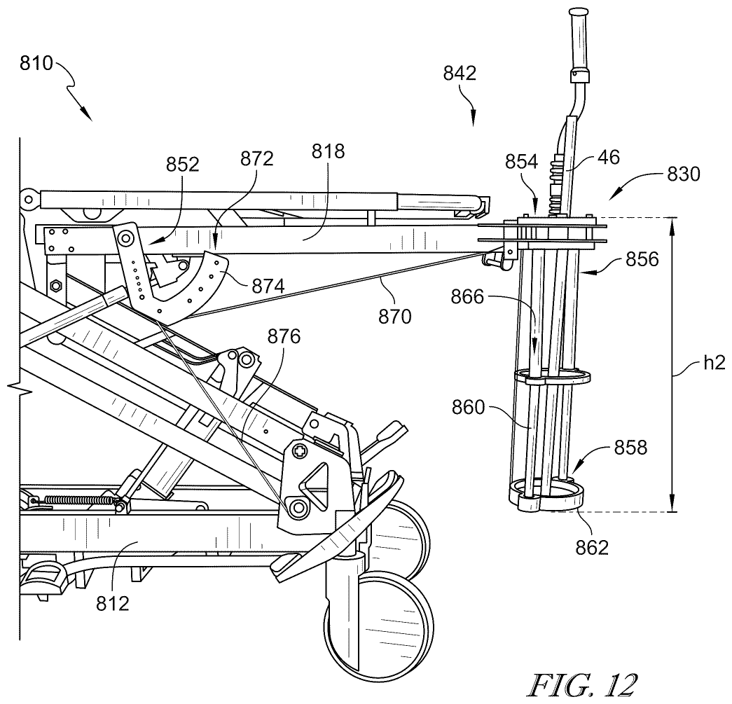

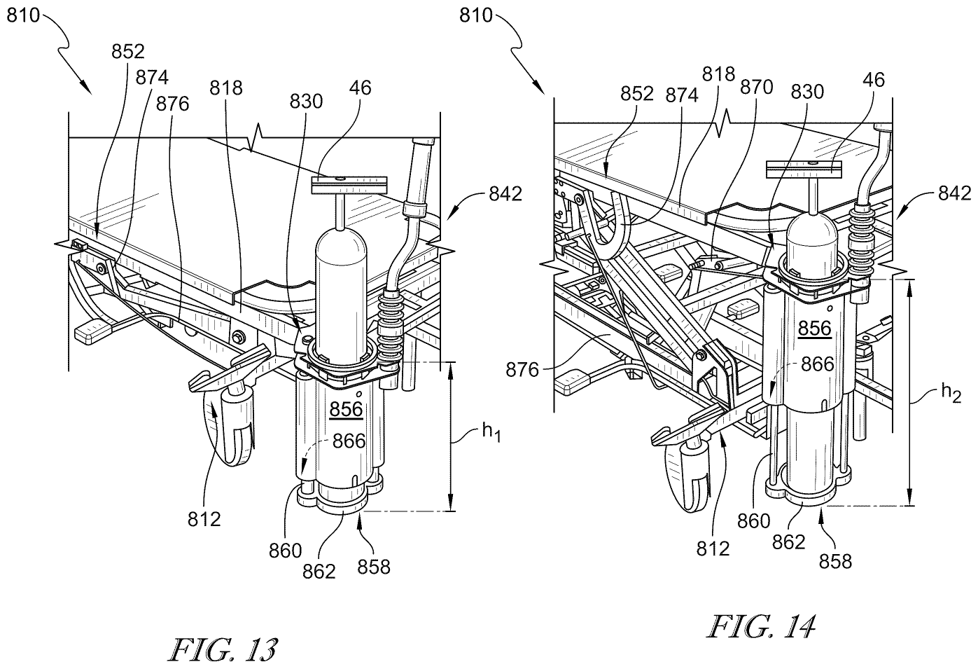

Referring now to FIGS. 11-14, another embodiment of a patient support apparatus 810 is similar to the embodiment in FIGS. 1-2B. The patient support apparatus 810 includes an oxygen tank support 830 coupled with an upper frame 818 of the patient support apparatus 810. The oxygen tank support 830 has an adjustable height as shown in FIGS. 12 and 14. The adjustable height oxygen tank support 830 allows the oxygen tank 46 to be stored at the head end 842 of the patient support apparatus 810 and varies in height so that the oxygen tank support 830 does not contact the floor when the upper frame is in the lowered position as shown in FIGS. 11 and 13. When the upper frame 818 is in the raised position, the oxygen tank support 830 expands into the open space between the upper frame 818 and the floor to support the oxygen tank 46 (depicted as model or stand-in oxygen tanks in FIGS. 11-14) at a desired height away from the floor to provide prompt access to the caregiver as suggested in FIGS. 12 and 14. The oxygen tank support 830 allows for Trendelenburg position and reverse Trendelenburg position when the upper frame 818 is in the raised position.

The oxygen tank support 830 includes a tank holder 854 and a height adjuster 852 as shown in FIGS. 11 and 12. The tank holder 854 is coupled with the upper frame 818 and has a variable height. The tank holder 854 is movable between a first height h₁ as shown in FIGS. 11 and 13 and a second arrangement having a second height h₂ as shown in FIGS. 12 and 14. The height adjuster 852 is coupled with the tank holder 854 and moves the tank holder 854 between the first arrangement and the second arrangement in response to movement of the upper frame 818 between the lowered position and the raised position. The tank holder 854 includes an upper support 856 coupled with the upper frame 818 and a lower support 858 movably coupled with the upper support 856.

The upper support 856 is arranged circumferentially around the oxygen tank 46 to limit movement and block tipping of the oxygen tank 46 as shown in FIGS. 11-14. The upper support 856 is fixed with the upper frame 818 at the head end 842 of the upper frame 818 such that a height of the upper support 856 relative to the floor is controlled by a height of the upper frame 818. The upper support 856 is formed to define guides holes 866 that receive the lower support 858 and direct movement of the lower support 858 relative to the upper support 856 as suggested in FIGS. 13 and 14.

The lower support 858 includes an end wall 862 that supports a bottom of the oxygen tank 46 and one or more guide rails 860 that extend away from the end wall 862 and into the guide holes 866 formed in the upper support 856 as shown in FIGS. 11-14. The end wall 862 extends around the bottom of the oxygen tank 46 and includes a lip that limits movement of the oxygen tank 46 in the end wall 862. The at least one guide rail 860 includes two guide rails 860 in the present embodiment. Each guide rail 860 extends upwardly away from the end wall 862 and into corresponding guide holes 866 formed in the upper support 856. In some embodiments, the guide rails 860 may interface with tracks, rails, rollers, or any other suitable alternative on the upper support 856. In some embodiments, the guide rails are included in the upper support and the lower support includes guiding features such as holes, rails, tracks, rollers, etc.

The guide rails 860 are configured to slide in the guide holes 866 to provide telescoping action between the lower support 858 and the upper support 856 as suggested in FIGS. 11 and 12. As discussed in great detail below, the height adjuster 852 is arranged to cause the lower support 858, and the oxygen tank 46 supported thereon, to move upwardly and downwardly relative to the upper support 856 in response to vertical movement of the upper frame 818.

When the upper frame 818 is in the lowered position, the guide rails 860 of the lower support 858 are moved into or further into the guide holes 866 of the upper support 856 to cause the end wall 862 to be proximate the upper support 856 and the tank holder 854 to have the first height h₁ as shown in FIGS. 11 and 13. In this arrangement, more of a top end of the oxygen tank 46 is exposed above the upper support 856 as shown in FIG. 13.

When the upper frame 818 is in the raised position, the guide rails 860 of the lower support 858 are moved out of or further out of the guide holes 866 of the upper support 856 to cause the upper support 856 to move away from the end wall 862 and the tank holder 854 to have the first height h₂ as shown in FIGS. 12 and 14. In this arrangement, less of a top end of the oxygen tank 46 is exposed above the upper support 856 as shown in FIG. 14. Because the lower support 858 is telescoping coupled with the upper support 856, the end wall 862 and the oxygen tank 46 move upward relative to the floor less than the upper support 856 in response to the upper frame 818 moving to the raised position. In some embodiments, the end wall 862 and the oxygen tank 46 do not move upwardly any amount in response to the upper frame moving between the lowered position and the raised position. With less of the top of the oxygen tank 46 extending above the upper support 856 and upper frame 818, greater access to the patient is available to the caregiver to provide therapy to the patient or to transfer the patient to another surface, for example.

The height adjuster 852 illustratively includes a cable 870 and a cam unit 872 as shown in FIGS. 11 and 12. The cable 870 is coupled with the lower support 858 of the tank holder 854 and with the cam unit 872. The cam unit 872 is coupled with the upper frame 818 and the base 812 and allows the upper support 856 to move relative to the lower support 858 and the oxygen tank 46 in response to the upper frame 818 moving between the lowered position and the raised position.

The cam unit 872 includes a cam arm 874 for acting on the cable 870 and a link 876 coupled with the cam arm 874 for moving the cam arm 874 in response to movement of the upper frame 818 as shown in FIGS. 11 and 12. The cam arm 874 is pivotably coupled with the upper frame 818. The cam arm 874 in the illustrative embodiment is curved and formed with a groove with the cable 870 located in the groove and engaged with the curved surface of the cam arm 874. A first end of the cable 870 is coupled with the cam arm 874 and a second end of the cable 870 is coupled with the lower support 858 of the tank holder 854. The link 876 is pivotably coupled with the base 812 and with the cam arm 874 at a point offset from the pivot point of the cam arm 874. The link 876 is rigid in the illustrative embodiment.

In use, raising of the upper frame 818 relative to the base 812 results in the link 876 rotating the cam arm 874 which causes the cam arm 874 to allow the first end of the cable 870 to move toward the lower support 858 as suggested in FIGS. 13 and 14. The cable 870 holds the weight of the oxygen tank 46 and the lower support 858 such that the lower support 858 remains near the floor while the upper frame 818 and the upper support 856, coupled thereto, move upwardly away from the floor. Therefore, the vertical position of the oxygen tank 46 relative to ground is relatively unchanged as compared to the vertical position of the upper frame 818. As a result, a top of the oxygen tank 46 is low relative to the upper frame 818 to minimize obstruction to the patient and increase caregiver access.

When the upper frame 818 is moved toward the lowered position, as suggested by FIGS. 14 and 13, the cam unit 872 maintains the lower support 858 of the tank holder 854 and the oxygen tank 46 near the floor while the upper frame 818 and the upper support 856 of the tank holder 854 move downwardly. The link 876 rotates the cam arm 874 in response to the upper frame 818 moving downwardly toward the base 812. Rotation of the cam arm 874 moves the first end of the cable 870 away from the tank holder 854 which keeps the cable 870 taught as the lower support 858 is received in the upper support 856 and the height of the tank holder 854 is reduced.

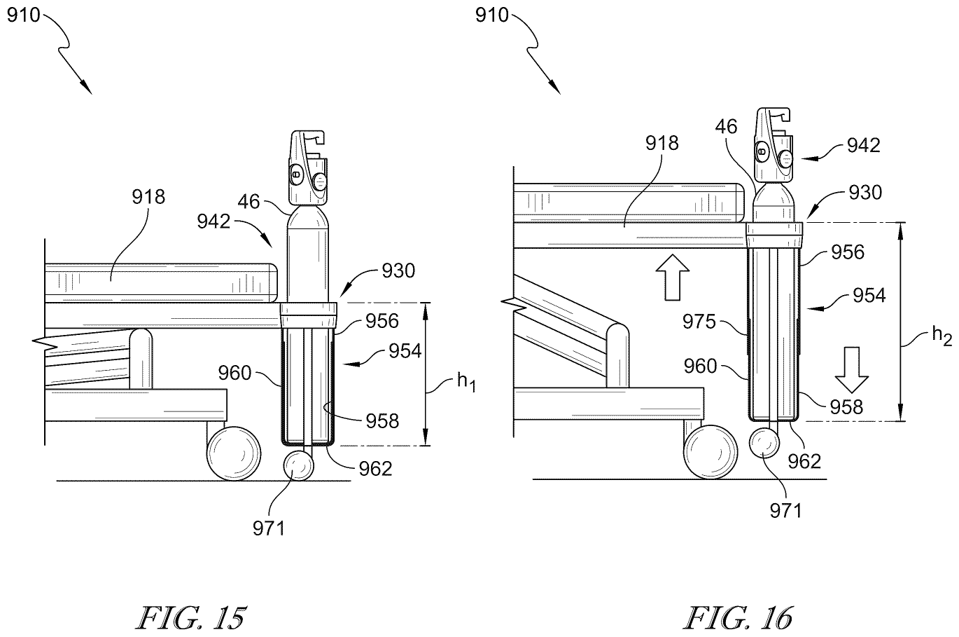

Referring now to FIGS. 15 and 16, another embodiment of a patient support apparatus 910 is similar to the embodiment in FIGS. 11-14. The patient support apparatus 910 includes an oxygen tank support 930 coupled with an upper frame 918 of the patient support apparatus 910. The oxygen tank support 930 has an adjustable height as shown in FIGS. 15 and 16. The adjustable height oxygen tank support 930 allows the oxygen tank 46 to be stored at the head end 942 of the patient support apparatus 910 and varies in height so that the oxygen tank 46 is supported on or near the floor when the upper frame 918 is in the lowered position. When the upper frame 918 is in the raised position, the oxygen tank support 930 expands into the open space between the upper frame 918 and the floor to support the oxygen tank 46 at a desired height away from the floor to provide prompt access to the caregiver as suggested in FIG. 16. The oxygen tank support 930 allows for Trendelenburg position and reverse Trendelenburg position when the upper frame 918 is in the raised position.

The oxygen tank support 930 is coupled with the upper frame 918 and has a variable height as suggested in FIGS. 15 and 16. The oxygen tank support 930 is movable between a first height h₁ as shown in FIG. 15 and a second arrangement having a second height h₂ that is greater than the first height h₂ as shown in FIG. 16. The oxygen tank support 930 moves between the first arrangement and the second arrangement in response to movement of the upper frame 918 between the lowered position and the raised position. The tank holder 954 includes an upper support 956 coupled with the upper frame 918 and a lower support 958 movably coupled with the upper support 956.

The upper support 956 is arranged circumferentially around the oxygen tank 46 to limit movement and block tipping of the oxygen tank 46 as shown in FIG. 15. The upper support 956 extends downwardly away from the upper frame 918 partway along a height of the oxygen tank 46. The upper support 956 is fixed with the upper frame 918 at the head end 942 of the upper frame 918 such that a height of the upper support 956 relative to the floor is controlled by a height of the upper frame 918.

The lower support 958 includes an end wall 962 that supports a bottom of the oxygen tank 46, a sidewall 960 that extend away from the end wall 962, and a wheel 971 coupled to the end wall 962 as shown in FIGS. 15 and 16. The wheel 971 is illustratively includes a swivel caster. The sidewall 960 is slidingly coupled with the upper support 956 to provide telescoping action between the upper support 956 and the lower support 958. In some embodiments, the sidewall 960 and the upper support 956 may interface with tracks, rails, rollers, or any other suitable alternative.

When the upper frame 918 is in the lowered position as shown in FIG. 15, one of the lower support 958 and the upper support 956 are telescopingly received by the other of the upper support 956 and the lower support 958 such that the oxygen tank support 930 has the first height h₁. The wheel 971 is engaged with the floor underlying the patient support apparatus 910 to support a weight of the lower support 958 and the oxygen tank 46. In response to the upper frame 918 moving toward the raised position as shown in FIG. 16, the upper support 956 moves upwardly with the upper frame 918. The weight of the oxygen tank 46 weighs on the lower support 958 and the upper support 956 slides upwardly away from the lower support 958 causing the oxygen tank support 930 to expand to the second height h₂. As a result, the oxygen tank 46 moves upwardly less than the upper support 956 and the upper frame 918 and a top of the oxygen tank 46 allows for prompt caregiver access to the oxygen tank 46 while increasing caregiver access to the patient. In the illustrative embodiment, the lower support 958 and the upper support 956 are sized such that the entire lower support 958 is spaced apart from the floor when the upper frame 918 is in its fully raised position as shown in FIG. 16. The lower support 958 and the upper support 956 include a stop feature 975, such as flanges for example, that block the lower support 958 from separating from the upper support 956.

When the upper frame 918 is lowered toward the lowered position, the lower support 958 moves downwardly with the upper support 956 until the lower support 958 engages the floor. Thereafter, the lower support 958 and the upper support 956 retract with telescoping action and the upper support 956 slide downwardly partway along the oxygen tank 46.

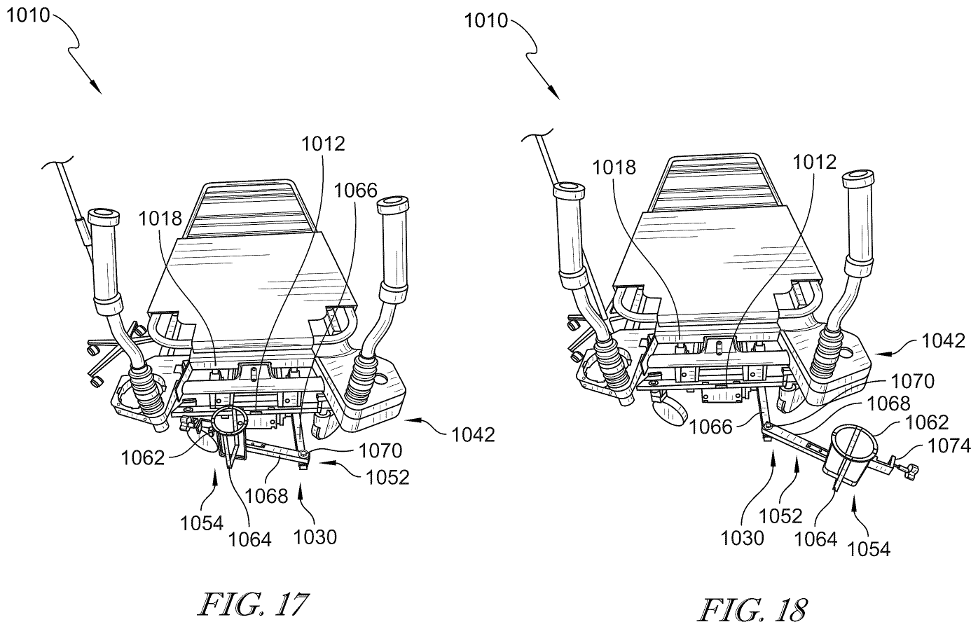

Referring now to FIGS. 17-21, another embodiment of a patient support apparatus 1010 is similar to the embodiments in FIGS. 1-4. The patient support apparatus 1010 includes an oxygen tank support 1030 coupled with an upper frame 1018 of the patient support apparatus 1010 and configured to move between a stored position and a plurality of use positions. The oxygen tank support 1030 can be stored at the head end 1042 of the patient support apparatus 1010 when not in use as suggested in FIG. 17. In the stored position, the oxygen tank support 1030 allows for Trendelenburg position and reverse Trendelenburg position when the upper frame 1018 is in the raised position. In the stored position, the oxygen tank support 1030 is located within a footprint of the upper frame 1018 when viewed vertically and in the plurality of use positions, the oxygen tank support 1030 is moved outside of the footprint. The oxygen tank support 1030 may be pivoted at one or more joints to one of a plurality of use positions to hold an oxygen tank 46 thereon and may be coupled with a rolling IV pole for movement with the patient support apparatus 1010 to provide rolling support of the oxygen tank 46 as suggested in FIGS. 18-21.

The oxygen tank support 1030 includes a mount 1052 and a tank holder 1054 as shown in FIGS. 17 and 18. The mount 1052 is rotatably coupled with a base 1012 of the patient support apparatus 1010 to pivot about an axis that extends vertically. The mount 1052 includes a pivot joint 1070 to allow the mount 1052 to expand and collapse to different lengths and arrangements. In other embodiments, the mount 1052 may extend linearly with or without pivoting relative to the patient support apparatus 1010. The tank holder 1054 is coupled with the mount 1052 for movement therewith and is configured to receive the oxygen tank 46 to hold the oxygen tank 46 with the oxygen tank support 1030. The tank holder 1054 includes a band 1062 configured to extend around the oxygen tank 46 and a plurality of rails 1064 that extend away from the band 1062 form walls to block tilting of the oxygen tank 46 and a bottom to support the weight of the oxygen tank 46.

The mount 1052 includes a first segment 1066 rotably coupled with the base 1012 and a second segment 1068 rotatably coupled with the first segment 1066 at the pivot joint 1070 to allow the first segment 1066 and the second segment 1068 to rotate relative to one another as suggested in FIGS. 17 and 18. The tank holder 1054 is fixed with the second segment 1068 in the illustrative embodiment. The mount 1052 is movable about the coupling with the base 1012 and about the pivot joint 1070 to move the oxygen tank support 1030 between the stored position as shown in FIG. 17 to a plurality of use positions as shown in FIGS. 18-21. The plurality of positions include infinitely continuous adjustment in the present embodiment.

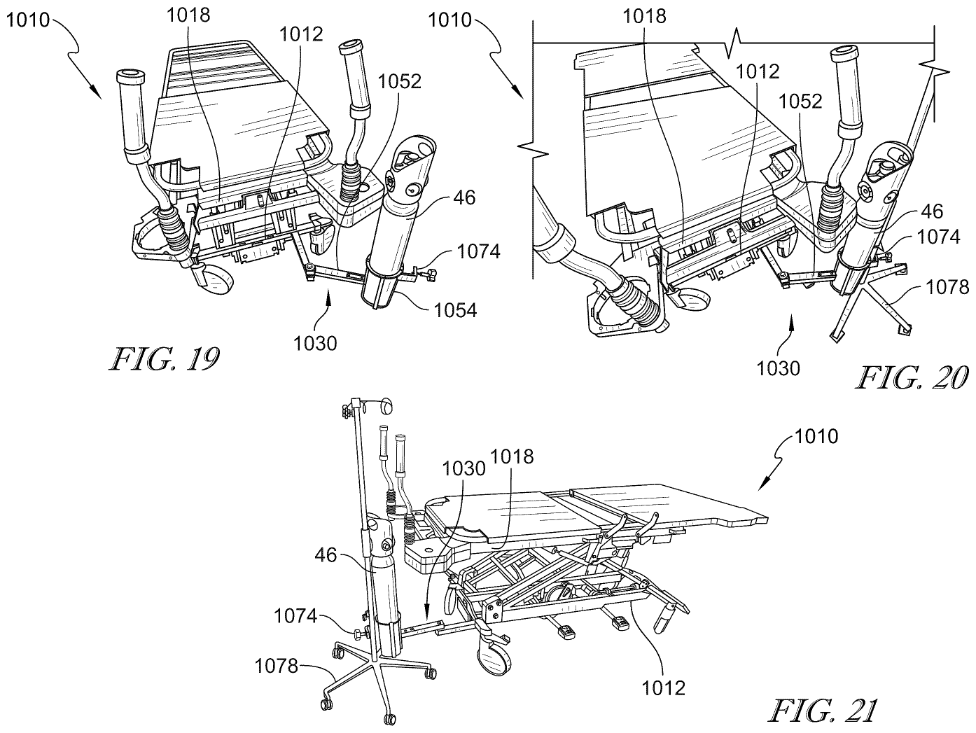

The coupling with the base 1012 and the pivot joint 1070 include friction clutches to resist unintentional movement of the mount 1052, for example, when the patient support apparatus 1010 is being moved along the floor. By overcoming the resistance of the friction clutch, the caregiver is able to rotate the first segment 1066 and the second segment 1068 of the mount 1052 manually with minimal force. As a result, the mount 1052 may be intentionally repositioned, but will resist unintentional movement of the oxygen tank 46. In particular, the oxygen tank support 1030 may be rotated to different positions to provide the caregiver greater access to the patient or to be moved out of the way when transferring the patient to another support surface. For example, the oxygen tank support 1030 may be rotated to a position along a side of the patient support apparatus as shown in FIGS. 19 and 20 or to a position behind a head end 1042 of the patient support apparatus 1010 as shown in FIG. 21. Positioning the oxygen tank support 1030 behind the head end 1042 of the patient support apparatus 1010 when moving the patient support apparatus 1010 through a doorway as an example.

The mount 1052 further includes an IV pole coupler 1074 as shown in FIGS. 18 and 19. The IV pole coupler 1074 includes a C-clamp in the illustrative embodiment. The IV pole coupler 1074 is fixed with the second segment 1068 of the mount 1052 and is adapted to be coupled, selectively, with an IV pole 1078 (such as a rolling IV pole). By coupling the IV pole 1078 to the oxygen tank support 1030 a majority of the weight of the oxygen tank 46 may be supported by the IV pole 1078. The rolling IV pole 1078 of the illustrative embodiment is configured to roll along the floor with the patient support apparatus pulling the IV pole 1078 to provide mobile support of the oxygen tank 46.

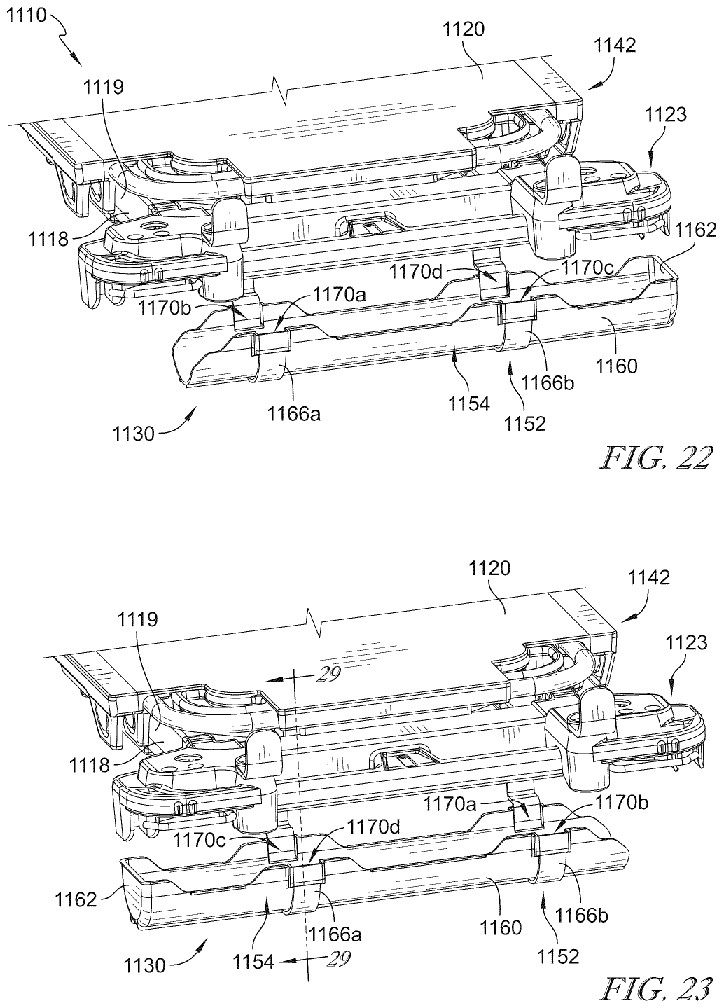

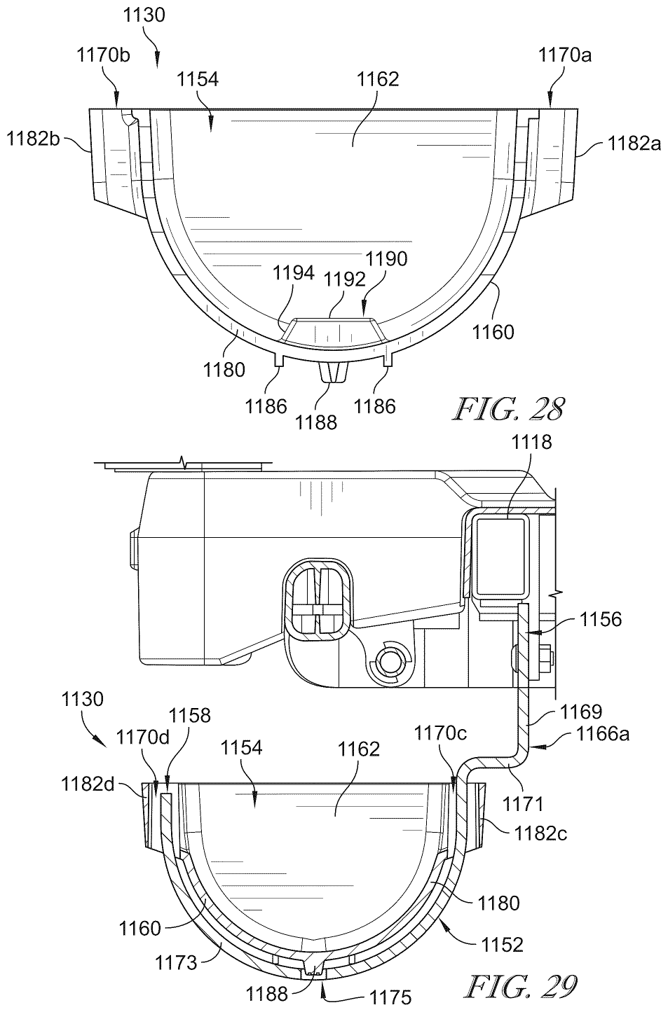

Referring now to FIGS. 22-35, another embodiment of a patient support apparatus 1110 is shown which is similar to the embodiment of the patient support apparatuses 710 in FIGS. 9 and 10. The patient support apparatus 1110 includes an oxygen tank support 1130 coupled with an upper frame 1118 of the patient support apparatus 1110. The oxygen tank support 1130 is coupled to a head end 1142 of the upper frame 1118 to provide caregiver access to the oxygen tank stored thereon near the head end 1142 of the upper frame 1118. In other embodiments, the oxygen tank support 1130 is coupled to lateral sides of the patient support apparatus 1110 similar to the positioning of oxygen tank supports shown in FIGS. 5-7.

The oxygen tank support 1130 is configured to locate the oxygen tank beneath (lower than) and substantially within a footprint of the upper frame 1118 or the deck coupled with the upper frame 1118. The oxygen tank support 1130 is configured to be repositionable by a caregiver to support the oxygen tank 46 with an orientation such that a valve end of the oxygen tank 46 is located on a first side or a second opposite side as suggested in FIGS. 22 and 23. As such, the location to access to the valves of the oxygen tank 46 can be change selectively depending on patient needs, equipment position, or caregiver preference. Moreover, locating the oxygen tank beneath the upper frame 1118 allows greater access to the patient by the caregiver. For example, conventional oxygen tank supports orient the oxygen tank vertically extending upwardly beyond the upper frame near a head of the patient and may inhibit a caregiver's arm and hand movements near the patient's head.

The patient support apparatus 1110 includes a base that supports a lift assembly which provides support of the upper frame 1118. The lift assembly moves the upper frame 1118 vertically when the lift assembly is activated between a raised position and a lowered position. The upper frame 1118 may be cantilevered on the lift assembly or may include one or multiple telescoping columns, scissor lift arms, or other suitable mechanisms for lifting the upper frame 1118 relative to the base. The upper frame 1118 illustratively includes a rigid frame 1119 and accessory support structures 1123 such as handles, levers, push rods, IV pole supports, etc. The upper frame 1118 of the illustrative patient support apparatus 1110 supports a patient deck 1120 that is substantially similar to deck 20.

The oxygen tank support 1130 includes a support mount 1152 and a tank holder 1154 coupled with the support mount 1152. The support mount 1152 is coupled to the upper frame 1118 of the patient support apparatus 1110 via welding, fasteners, or other suitable alternative. The tank holder 1154 includes a sidewall 1160 that extends at least partway about the oxygen tank 46 and an end wall 1162 that is configured to engage a bottom of the oxygen tank to block the oxygen tank from separating from the oxygen tank support 1130. The support mount 1152 is coupled with the frame 1118 for movement therewith. The tank holder 1154 is coupled with the support mount 1152 and configured to store the oxygen tank such that a longitudinal axis of the oxygen tank is positioned at an acute angle relative to horizontal, less than 90 degrees and including 0 degrees. In the illustrative embodiment, the angle is between 0 and 30 degrees.

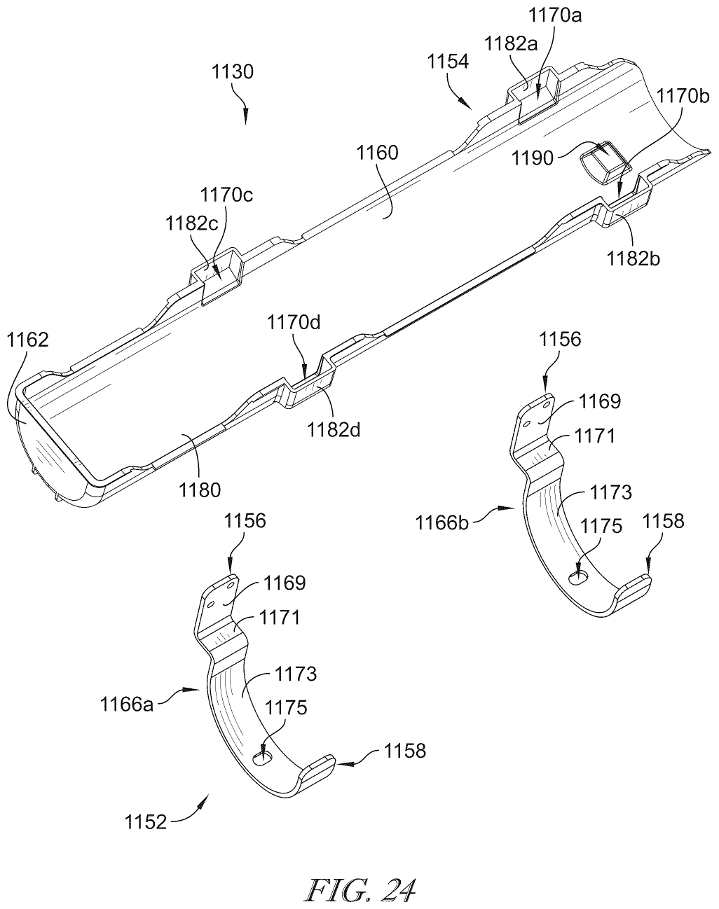

The support mount 1152 includes a plurality of mount arms 1166 as shown in FIG. 24. In the illustrative embodiment, the support mount 1152 includes two mount arms 1166a, 1166b spaced apart from one another in a lateral direction. Each of mount arms 1166 are substantially similar to each other. The mount arms 1166 each extend from a first end 1156 coupled with the upper frame 1118 to a second end 1158 thereof to couple to the sidewall 1160 of the tank holder 1154. In the illustrative embodiment, each mount arm 1166 is made from a plate of material that is formed into shape. The first end 1156 of each mount arm 1166 extends downwardly away from the upper frame 718 and then curves with an arcuate shape around a first side of the tank holder 1154 and terminates at the send end 1158 of the mount arm 1166 on a second side of the tank holder 1154.

Each mount arm 1166 includes a first segment 1169 at the first end 1156, a second segment 1171 extending from the first segment 1169, and a third segment 1173 extending from the second segment 1171 to the second end 1158 as shown in FIG. 24. The first segment 1169 is generally planar and extends vertically downward away from the upper frame 1118. The first segment 1169 is formed to include holes for receiving fasteners for coupling with the upper frame 1118; however, other suitable alternatives may be used to couple the first segment 1169 with the upper frame 1118. The second segment 1171 extends away from the first segment 1169 generally horizontally and is generally planar. The third segment 1173 extends downwardly away from the second segment 1171 and curves to extend upwardly at the second end 1158 of the mount arm 1166. The first segment, 1169, second segment 1171, and third segment 1173 may be joined together along curved bends.

The third segment 1173 may have a constant radius of curvature. In some embodiments, the third segment 1173 includes linear extending end portions and a curved intermediate portion interconnecting the end portions. The third segment 1173 provides the free terminating end 1158 of the mount arm 1166. The third segment 1173 is formed to define a recess 1175 for receiving a portion of the tank holder 1154 therein. Illustratively, the recess 1175 is provided by a through hole that extends through the third segment 1173. The recess 1175 may be elongated in the lateral direction as shown in FIG. 24. The third segment 1173 is curved to provide a channel with an opening facing the upper frame 1118.

The sidewall 1160 of the tank holder 1154 is configured to extend partway around the oxygen tank to form a large opening to receive the oxygen tank therein. The sidewall 1160 and the end wall 1162 are each configured to extend partway along the oxygen tank. The sidewall 1160 extends between a first end and a second end of the tank holder 1154. The sidewall 1160 opens to atmosphere at the first end to provide a mouth for receiving the oxygen tank and the end wall 1162 is located at the second end to cap the cavity in the sidewall 1160 and block the oxygen tank from escaping the tank holder 1154 from the second end.

The sidewall 1160 is formed to include openings 1170a-1170d and the mount arms 1166 each extend through a corresponding opening 1170a-d as shown in FIGS. 22 and 23. The opening 1170a is formed on a first side of the sidewall 1160, the opening 1170b is formed on a second side of the sidewall 1160 opposite the opening 1170a, the opening 1170c is formed on the first side of the sidewall 1160 and spaced apart from the opening 1170a, and the opening 1170d is formed on the second side of the sidewall 1160 and spaced apart from the opening 1170b. The opening 1170a is aligned in the lateral direction with opening 1170b and the opening 1170c is aligned in the lateral direction with opening 1170d. The openings 1170a, 1170c may be referred to as first openings and openings 1170b, 1170d may be referred to as second openings, or vice versa. In some embodiment, the sidewall 1160 includes a single opening 1170 on each side and such openings may be generally centrally located along the length of the sidewall.

The tank holder 1154 is repositionable between a first orientation and the second orientation as shown in FIGS. 22, 23, and 30-35. In the first orientation of the tank holder 1154, the first mount arm 1166a extends through the openings 1170a, 1170b and the second mount arm 1166b extends through the openings 1170c, 1170d. In the second orientation of the tank holder 1154, the first mount arm 1166a extends through the openings 1170c, 1170d and the second mount arm 1166b extends through the openings 1170a, 1170b.

The sidewall 1160 includes a body 1180 and channel bands 1182a, 1182b, 1182c, 1182d as shown in FIGS. 24-27. The body 1180 extends between the first and second ends of the tank holder 1154 and defines the cavity for receiving the oxygen tank. The channel bands 1182a-d extend away from the body 1180 to form the openings 1170a-d in the illustrative embodiment. In other embodiments, the openings 1170a-d may be formed entirely in the body 1180. Each channel band 1182a-d extends away from the body 1180 turns to extend parallel with the body 1180 and turns again toward and interconnects with the body 1180. The channel bands 1182a-d form rectangular openings 1170a-d in the illustrative embodiment.

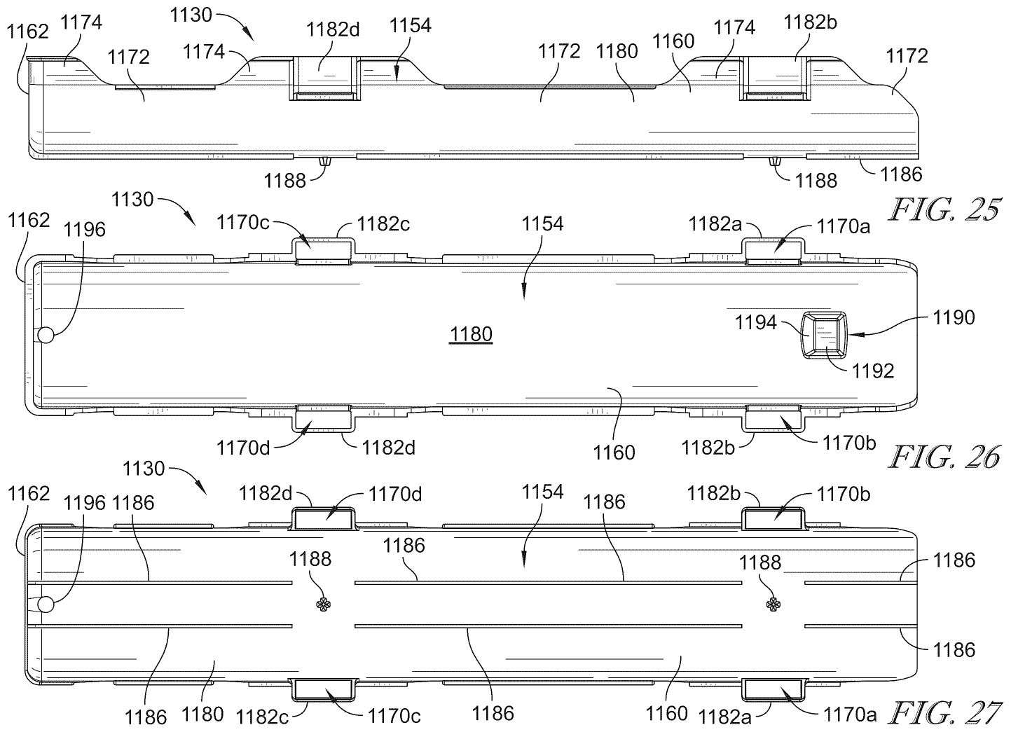

The sidewall 1160 includes first segments 1172 that extends circumferentially about an axis of the tank holder 1154 a first distance as shown in FIG. 25. The sidewall 1160 includes a second segments 1174 that extends circumferentially about the axis of the tank holder 1154 a second distance that is greater than the first distance. The end wall 1162 is coupled with one of the second segments 1174. The first segments 1172 include tapered walls that extend from an adjacent second segment 1174 at the second distance to the lower first distance. The illustrative sidewall 1160 includes three first segments 1172 and three second segments 1174. The channel bands 1182a-d extend from the second segments 1174.

The sidewall 1160 optionally includes rails 1186 and one or more anti-rotation tabs 1188 as shown in FIGS. 25-29. The rails 1186 are configured to engage the third segment 1173 of the mount arms 1166 to provide a datum contact surface. The anti-rotation tabs 1188 resist rotation of the tank holder 1154 relative to the mount arms 1166.

The rails 1186 extend away from the body 1180 of the sidewall 1160 and along a length of the body 1180. The rails 1186 may space the body 1180 apart from the mount arms 1166. The rails 1186 may extend partway along a bottom of the body 1180 of the sidewall 1160, may include multiple rail segments with gaps therebetween as shown in FIG. 27, or may extend entirely along the length of the body 1180 without interruption. The sidewall 1160 includes two rows of rails 1186 spaced apart from one another as shown in FIG. 27. The anti-rotation tabs 1188 extend away from the body 1180. The pair of rails 1186 extend parallel to each other.

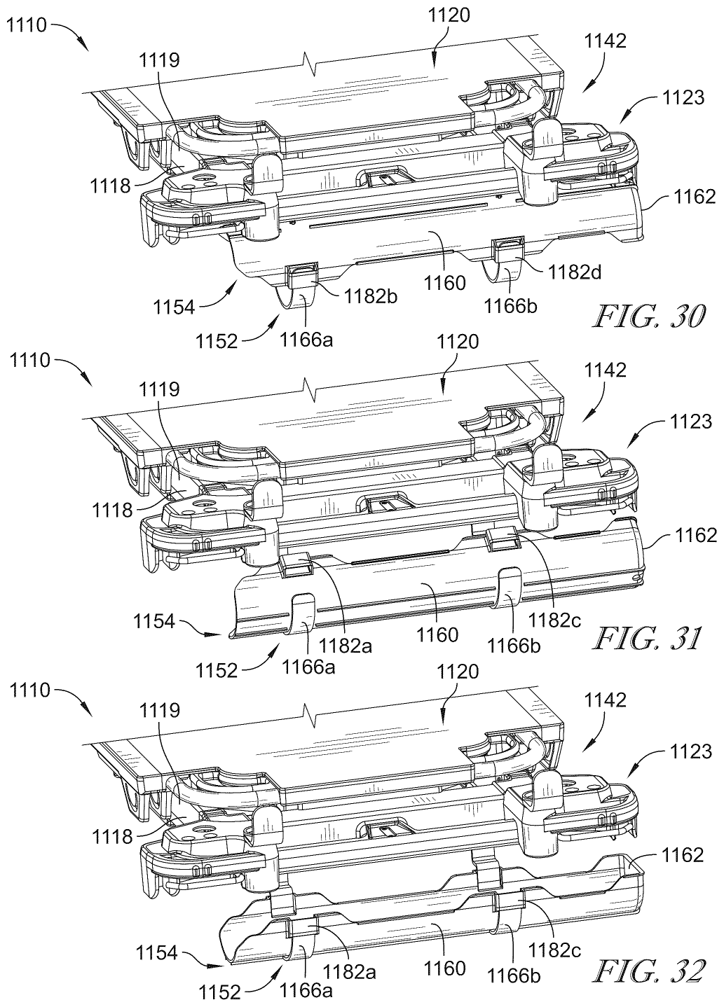

Each anti-rotation tab 1188 is discrete and sized to be received in one of the corresponding recesses 1175 formed in the mount arms 1166. The anti-rotation tabs 1188 are configured to engage the mount arms 1166 to resist rotation of the tank holder 1154 relative to the mount arms 1166. The tank holder 1154 has sufficient tolerances that a caregiver may slightly lift the tank holder 1154 to move the anti-rotation tabs out of the recesses 1175 to allow intentional rotation of the tank holder 1154 as suggested in FIGS. 30-35. Each anti-rotation tab 1188 is cross shaped in the illustrative embodiment. The anti-rotation tabs 1188 are located near the bottom center of the body 1180 and located between parallel rails 1186. The anti-rotation tabs 1188 may be located on other portions of the body 1180 in other embodiments.

The sidewall 1160 optionally includes a protrusion 1190 for resisting sliding movement of the oxygen tank in the cavity as shown in FIG. 24. The protrusion 1190 extends upwardly away from a bottom of the body 1180 toward the upper frame 1118. The protrusion 1190 may have a rectangular footprint. Illustratively, the protrusion has a generally flat top surface 1192 and angled side surfaces 1194 that extend between and interconnect the top surface 1192 and the body 1180. The tank holder 1154 and all features thereof such as the protrusion 1190, rails 1186, tabs 1188, body 1180, and channel bands 1182 are integrally formed as a one-piece component in the illustrative embodiment.

The sidewall 1160 optionally includes a fluid drain hole 1196 for allowing any fluids in the cavity to escape the cavity through the fluid drain hole 1196 as shown in FIGS. 26 and 27. The fluid drain hole 1196 is formed in the body 1180 and located near the end wall 1162. The sidewall 1160 may be angled relative to the horizontal such that any fluid is urged by gravity toward the fluid drain hole 1196.

The sidewall 1160 includes a curved segment that has a radius of curvature relative to an axis and wherein the axis extends at an angle between 0 and 45 degrees relative to horizontal. In some embodiments, the angle is about 0 degrees. In some embodiments, the angle is between about 0 and 30 degrees. In some embodiments, the angle is between about 0 and 20 degrees. In some embodiments, the angle is between about 0 and 10 degrees. As a result, the oxygen tank support 1130 is arranged to orient the oxygen tank generally horizontal at angle between 0 and 45 degrees relative to ground in the illustrative embodiment in both the first orientation of the tank holder 1154 and the second orientation of the tank holder 1154. In some embodiments, the oxygen tank support 1130 locates the oxygen tank 46 substantially within a lateral footprint of the upper frame 1118 or a support surface of a deck 1120 on the upper frame 1118 such that the oxygen tank support 1130 and oxygen tank 46 do not increase a lateral width of the patient support apparatus 1110. The oxygen tank support 1130 remains spaced apart from the floor when the patient support apparatus 1110 is in the lowered position. The oxygen tank support 1130 allows for Trendelenburg position and reverse Trendelenburg position when the upper frame 1118 is in the raised position. As such, the movement envelope of the patient support apparatus 1110 is unchanged with the inclusion of the oxygen tank support 1130.

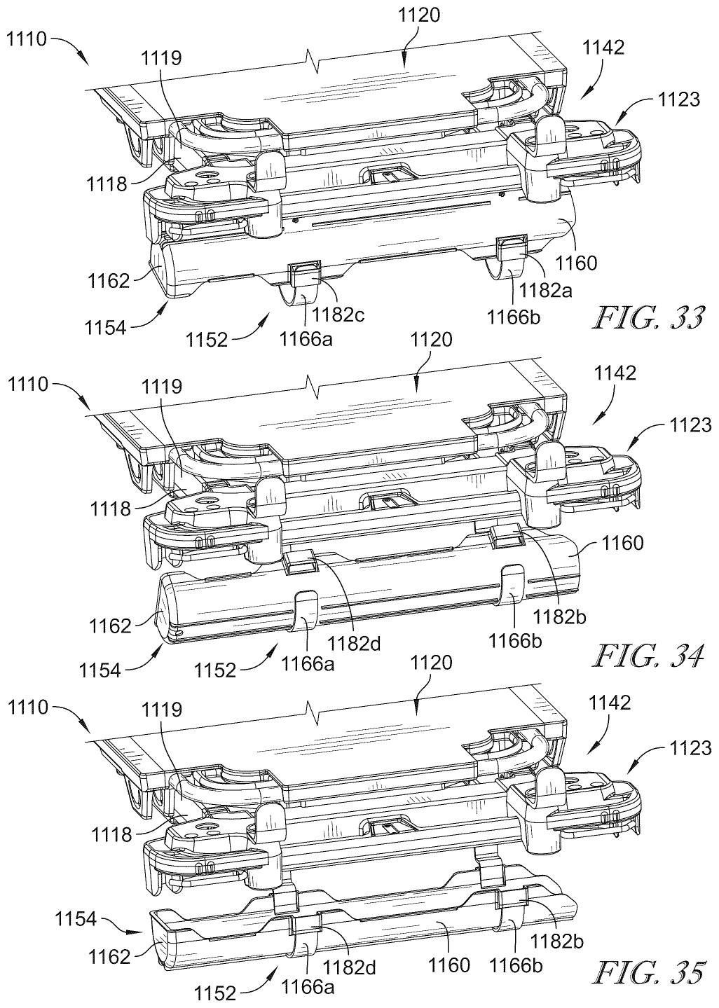

When using the oxygen tank support 1130, the tank holder 1154 may be installed in the first orientation as shown in FIGS. 30-32 or the second orientation as shown in FIGS. 33-35 as the option of the caregiver or other installer. The first segment 1169 of the first mount arm 1166a is coupled with the upper frame 1118 and the first segment 1169 of the second mount arm 1166b is coupled with the upper frame 1118 to fix the first mount arm 1166a and the second mount arm 1166b with the upper frame 1118.

To install the tank holder 1154 in the first orientation, the opening 1170b of the tank holder 1154 is aligned with the first mount arm 1166a of the oxygen tank support 1152 that is coupled with the upper frame 1118 of the patient support apparatus 1110. The tank holder 1154 is positioned so that the bottom of the tank holder 1154 faces the upper frame 1118 and the opening into the cavity of the sidewall 1160 faces the floor as shown in FIG. 30. As a result, the openings 1170a, 1170c are located between the first segment 1169 of the first mount arm 1166a and the openings 1170b, 1170d. Likewise, the second opening 1170d of the tank holder 1154 is aligned with the second mount arm 1166b.

The tank holder 1154 is rotated by the caregiver in a first direction relative to the first mount arm 1166a and the second mount arm 1166b so that first mount arm 1166a extends through the opening 1182b as shown in FIG. 30 and then through the opening 1182a of the tank holder 1154 after passing through the opening 1182b as shown in FIG. 31 to cause the tank holder 1154 to be supported on the first mount arm 1166a in the first orientation as shown in FIG. 33. Rotating the tank holder 1154 in the first direction further causes the second mount arm 1166b to extend through the opening 1182d as shown in FIG. 30 and then through the opening 1182c of the tank holder 1154 after passing through the opening 1182d as shown in FIG. 31 to cause the tank holder 1154 to be supported on the second mount arm 1166b in the first orientation as shown in FIG. 32. The anti-rotation tabs 1188 are located in the recesses 1175 of the mount arms 1166 to resist unintentional rotation of the tank holder 1154. The first end of the tank holder 1154 is located on a first side of the patient support apparatus 1110 and the second end and end wall 1162 are located on a second side of the patient support apparatus 1110.

The oxygen tank may then be placed in the tank holder 54 by inserting the oxygen tank through the first end and/or opening of the channel of the tank holder 1154. The valve end of the oxygen tank is then located adjacent the first end of the tank holder 1154, the first mount arm 1166a, and openings 1170a, 1170b. The bottom end of the oxygen tank is located near the end wall 1162 and configured to be engaged by the end wall 1162 to block the oxygen tank from escaping the second end of the tank holder 1154. The protrusion 1190 may extend into a space formed by a curvature or termination of the valve end of the oxygen tank so that movement of the oxygen tank toward the opening at the first end of the tank holder 1154 causes the protrusion to engage a body of the oxygen tank and resist further movement in that direction.

To remove the tank holder 1154, the tank holder 1154 is rotated in a second direction opposite the first direction relative to the first mount arm 1166a so that the first mount arm 1166a is removed from the openings 1170a, 1170b and the second mount arm 1166b is removed from the openings 1170c, 1170d. The tank holder 1154 may then be repositioned for the second orientation as suggested in FIGS. 33-35.

To install the tank holder 1154 in the second orientation, the opening 1170c of the tank holder 1154 is aligned with the first mount arm 1166a of the oxygen tank support 1152 that is coupled with the upper frame 1118 of the patient support apparatus 1110. The tank holder 1154 is positioned so that the bottom of the tank holder 1154 faces the upper frame 1118 and the opening into the cavity of the sidewall 1160 faces the floor as shown in FIG. 33. As a result, the openings 1170b, 1170d are located between the first segment 1169 of the first mount arm 1166a and the openings 1170a, 1170c. Likewise, the opening 1170a of the tank holder 1154 is aligned with the second mount arm 1166b.

The tank holder 1154 is rotated by the caregiver in the first direction relative to the first mount arm 1166a and the second mount arm 1166b so that first mount arm 1166a extends through the opening 1182c as shown in FIG. 33 and then through the opening 1182d of the tank holder 1154 after passing through the opening 1182c as shown in FIG. 34 to cause the tank holder 1154 to be supported on the first mount arm 1166a in the second orientation as shown in FIG. 35. Rotating the tank holder 1154 in the first direction further causes the second mount arm 1166b to extend through the opening 1182a as shown in FIG. 31 and then through the opening 1182b of the tank holder 1154 after passing through the opening 1182a as shown in FIG. 34 to cause the tank holder 1154 to be supported on the second mount arm 1166b in the second orientation as shown in FIG. 353. The anti-rotation tabs 1188 are located in the recesses 1175 of the mount arms 1166 to resist unintentional rotation of the tank holder 1154. The first end of the tank holder 1154 is located on the second side of the patient support apparatus 1110 and the second end and end wall 1162 are located on the first side of the patient support apparatus 1110.

The oxygen tank may then be placed in the tank holder 54 by inserting the oxygen tank through the first end and/or opening of the channel of the tank holder 1154. The valve end of the oxygen tank is then located adjacent the first end of the tank holder 1154, the first mount arm 1166a, and openings 1170a, 1170b.

While the disclosure has been illustrated and described in detail in the drawings and the foregoing description, such illustration and description are to be considered illustrative or exemplary and not restrictive. The disclosure is not limited to the disclosed embodiments. From reading the present disclosure, other modifications will be apparent to a person skilled in the art. Such modifications may involve other features, which are already known in the art and may be used instead of or in addition to features already described herein. In the claims, the word “comprising” does not exclude other elements or steps, and the indefinite article “a” or “an” does not exclude a plurality.

Although this disclosure refers to specific embodiments, it will be understood by those skilled in the art that various changes in form and detail may be made without departing from the subject matter set forth in the accompanying claims.

1. A patient support apparatus comprising:
a frame operable to move vertically relative to a floor underlying the frame, and
an oxygen tank support coupled with the frame for storing an oxygen tank thereon, the oxygen tank support including a tank holder and a support mount coupled the frame for movement therewith, the tank holder being configured to couple with the support mount in a first orientation of the tank holder and a second orientation of the tank holder.

2. The patient support apparatus of claim 1, wherein the tank holder is formed to define a first opening on a first side of the tank holder and a second opening on a second side of the tank holder and the support mount extends through each of the first opening and the second opening in both the first orientation and the second orientation of the tank holder.

3. The patient support apparatus of claim 1, wherein the support mount includes a first mount arm coupled with the frame and extending away from the frame and around at least a portion of the tank holder.

4. The patient support apparatus of any of claim 1, wherein the tank holder is formed to include a cavity that opens toward the frame and mouth that opens into the cavity on a lateral end of the tank holder, the mouth is located toward a first end of the frame in response to the tank holder being in the first orientation, and the mouth is located toward a second end of the frame opposite the first end in response to the tank holder being in the second orientation.

5. The patient support apparatus of any of claim 4, wherein tank holder includes a sidewall extending between a first end and a second end of the tank holder and formed to define the cavity for receiving the oxygen tank therein and an end wall located at the first end of the oxygen tank holder and configured to engage a bottom of the oxygen tank, and the support mount extends at least partway around the sidewall to couple the tank holder with the frame.

6. The patient support apparatus of any of claim 5, wherein the sidewall is formed to define a first opening and the support mount includes a first mount arm coupled with the frame and extending through the first opening and at least partway around the sidewall of the tank support.

7. The patient support apparatus of claim 6, wherein the sidewall is formed to define a second opening spaced apart from and opposite the first opening and the first mount arm extends through the second opening.

8. The patient support apparatus of claim 7, wherein the sidewall is formed to define a third opening spaced laterally apart from the first opening and a fourth opening spaced apart from and opposite the third opening and the support mount includes a second mount arm coupled with the frame and extending through the third opening and the fourth opening.

9. The patient support apparatus of claim 5, wherein the sidewall includes a curved segment that has a radius of curvature relative to an axis and wherein the axis extends between 0 and 45 degrees relative to horizontal.

10. The patient support apparatus of claim 1, wherein the frame includes a head end and a foot end spaced apart from the head end and a transverse side that extends between the head end and the foot end, and the oxygen tank support is coupled to one of the head end of the frame and the transverse side of the frame.

11. A patient support apparatus comprising:
a frame operable to move vertically relative to a floor underlying the frame, and
an oxygen tank support for storing an oxygen tank thereon, the oxygen tank holder including a support mount coupled with the frame for movement therewith and a tank holder coupled with the support mount and configured to store the oxygen tank such that a longitudinal axis of the oxygen tank is positioned at an acute angle relative to horizontal.

12. The patient support apparatus of claim 11, wherein the frame includes a head end and a foot end spaced apart from the head end and a transverse side that extends between the head end and the foot end, and the oxygen tank support is coupled to one of the head end of the frame and the transverse side of the frame.

13. The patient support apparatus of claim 12, wherein the support mount includes a first mount arm coupled with the frame and the tank holder includes a sidewall coupled with the first mount arm and configured to extend at least partway around the oxygen tank and a bottom wall coupled with the sidewall and configured to engage a bottom of the oxygen tank.

14. The patient support apparatus of claim 13, wherein the support mount includes a second mount arm coupled with the frame and wherein the sidewall is formed to include a first aperture and a second aperture, the first mount arm extends through the first aperture, and the second mount arm extends through the second aperture.

15. The patient support apparatus of claim 12, further including a deck coupled with the upper frame and the oxygen tank support is located within a footprint of the deck when viewed from above.

16. A method of assembling an oxygen tank support on a patient support apparatus, the method comprising:
aligning a first opening of a tank holder included in the oxygen tank support with a first mount arm of the oxygen tank support coupled with an upper frame of the patient support apparatus, and
rotating the tank holder in a first direction relative to the first mount arm so that first mount arm extends through the first opening and then through a second opening of the tank holder after passing through the first opening to cause the tank holder to be supported on the first mount arm in a first orientation.

17. The method of claim 16, further comprising rotating the tank holder in a second direction relative to the first mount arm so that the first mount arm is removed from the first opening and the second opening,
aligning the second opening of the tank holder included in the oxygen tank support with the first mount arm,
rotating the tank holder in the first direction relative to the first mount arm so that first mount arm extends through the second opening and then through the first opening of the tank holder after passing through the second opening to cause the tank holder to be supported on the first mount arm in a second orientation.

18. The method of claim 17, further comprising aligning a third opening of the tank holder with a second mount arm of the oxygen tank support coupled with the upper frame of the patient support apparatus and spaced apart from the first mount arm, wherein rotating the tank holder in the first direction relative to the first mount arm causes the second mount arm to extend through the third opening and then through a fourth opening of the tank holder after passing through the third opening to cause the tank holder to be supported on the second mount arm in the first orientation.

19. The method of claim 16, further comprising locating an anti-rotation tab that extends from a body of the tank holder into a recess formed in the first mount arm.

20. The method of claim 16, further comprising coupling the first mount arm with the upper frame prior to aligning the first opening of the tank holder included in the oxygen tank support with the first mount arm, and wherein the first mount arm is rigid and includes a first segment that extends downwardly away from the upper frame and a second segment that is curved to provide a channel with an opening facing the upper frame.
